(19) United States
(12) Patent Application Publication
(10) Pub. No.: US 2022/0159156 A1
(43) Pub. Date: May 19, 2022

(54) OPTICAL SYSTEM, LENS MODULE, AND ELECTRONIC DEVICE

(71) Applicant: JIANGXI JINGCHAO OPTICAL CO., LTD., Nanchang (CN)

(72) Inventors: Wenyan ZHANG, Nanchang (CN); Hairong ZOU, Nanchang (CN)

(21) Appl. No.: 17/591,770

(22) Filed: Feb. 3, 2022

Related U.S. Application Data
(63) Continuation of application No. PCT/CN2019/099667, filed on Aug. 7, 2019.

(51) Int. Cl. H04N 5/225; G02B 9/64; G02B 7/02

(52) U.S. Cl. CPC H04N 5/2254; G02B 9/64; G02B 13/0045; H04N 5/2253; G02B 7/021

(57) ABSTRACT

An optical system, a lens module, and an electronic device are provide. The optical system includes, in order from an object side to an image side along an optical axis, a first lens with a refractive power, a second lens with a refractive power, a third lens with a positive refractive power, a fourth lens with a negative refractive power, a fifth lens with a positive refractive power, a sixth lens with a negative refractive power, and a seventh lens with a refractive power. The second lens has an object-side surface which is convex and an image-side surface which is concave. The third lens has an image-side surface which is convex. The fourth lens has an object-side surface which is concave and an image-side surface which is convex. The optical system further includes a stop, and the optical system satisfies the following expression: 1.2<Imgh/fno×L<1.4.

### CROSS-REFERENCE TO RELATED APPLICATION(S)

The present application is a continuation of International Application No. PCT/CN2019/099667, filed on Aug. 7, 2019, the disclosure of which is hereby incorporated by reference in its entirety.

### TECHNICAL FIELD

The present disclosure relates to the field of optical imaging technology, and particularly to an optical system, a lens module, and an electronic device.

### BACKGROUND

Recently, electronic devices such as smart phones and tablet computers are generally provided with cameras for image capturing and video shooting. With the technological development of the electronic devices, the cameras are required to have higher performance.

As the electronic devices tend to be miniaturized and thinned, there are various limitations in arranging high-performance cameras in such electronic devices. For example, it is difficult to realize a shooting camera.

A traditional wide-angle camera is usually provided with a five-piece or six-piece lens structure. With the development of the electronic device, the traditional wide-angle camera cannot meet the requirements in terms of definition, luminous flux, and an angle of view.

### SUMMARY

The present disclosure aims at providing an optical system, a lens module, and an electronic device, and the optical system can achieve characteristics of large wide-angle.

Technical solutions are provided hereinafter to achieve an objective of the present disclosure.

In a first aspect, an optical system is provided in implementations of the present disclosure. The optical system includes, in order from an object side to an image side along an optical axis, a first lens with a refractive power, a second lens with a refractive power, a third lens with a positive refractive power, a fourth lens with a negative refractive power, a fifth lens with a positive refractive power, a sixth lens with a negative refractive power, and a seventh lens with a refractive power. The second lens has an object-side surface which is convex and an image-side surface which is concave. The third lens has an image-side surface which is convex. The fourth lens has an object-side surface which is concave and an image-side surface which is convex. The optical system further includes a stop, and the optical system satisfies the following expression: 1.2<Imgh/fno×L<1.4; where Imgh represents half of a diagonal length of an imaging plane of the optical system, fno represents an F-number of the optical system, and L represents an aperture of the stop.

An appropriate configuration in a surface profile and a refractive power of each lens of the first to seventh lenses ensures that the optical system meets requirements of high-definition large-scale scene shooting. At the same time, an appropriate value of Imgh/fnoxL can make a sufficient amount of light enter the optical system and make the optical system have a long depth of field, so that both distant and near objects can show clear shooting effect, which realizes high-definition large-scale scene shooting, and ensures shooting quality.

In an implementation, the first lens has an object-side surface which is concave at the optical axis and an image-side surface which is convex at the optical axis, and the object-side surface of the first lens is convex at a periphery of the object-side surface of the first lens and the image-side surface of the first lens is concave at a periphery of the image-side surface of the first lens, which can increase a field of view of the optical system.

In an implementation, the fifth lens has an object-side surface which is concave at the optical axis and an image-side surface which is convex at the optical axis, and the image-side surface of the fifth lens is concave at a periphery of the image-side surface of the fifth lens. The fifth lens converges lights, which is beneficial to reducing a total length of the optical system on the optical axis and realizing miniaturization.

In an implementation, the sixth lens has an object-side surface which is convex at the optical axis and an image-side surface which is concave at the optical axis, and the seventh lens has an object-side surface which is convex at the optical axis and an image-side surface which is concave at the optical axis. The object-side surface of the sixth lens is concave at a periphery of object-side surface of the sixth lens and the image-side surface of the sixth lens is convex at a periphery of the image-side surface of the sixth lens, and the object-side surface of the seventh lens is concave at a periphery of the object-side surface of the seventh lens and the image-side surface of the seventh lens is convex at a periphery of the image-side surface of the seventh lens. The configuration of the sixth lens is beneficial to a correction of chromatic aberration of the optical system.

In an implementation, the optical system satisfies the following expression: 1<D1/Imgh<1.4; where D1 represents a clear aperture diameter of the first lens. An aperture diameter of the first lens determines how much object space information can be acquired by the optical system. Therefore, an appropriate ratio of the aperture diameter of the first lens to an image height needs be satisfied.

In an implementation, the optical system satisfies the following expression: 2<D1/L<3.5; where D1 represents a clear aperture diameter of the first lens of the optical system. The aperture diameter of the first lens determines how much object space information can be acquired by the optical system. The stop is used to improve the optical performance. An appropriate value of D1/L can meet miniaturization design requirements. At the same time, the optical performance is good, and the aberration correction is easy, which meets the requirements of large-scale scene shooting.

In an implementation, the optical system satisfies the following expression: 90°<FOV<110°; where FOV represents an angle of view of the optical system. The field of view of the optical system is large, and large-area scenes can be shot, which meets the requirements of large-scale scene shooting.

In an implementation, the optical system satisfies the following expression: 1.1<Imgh/f<1.3; where Imgh represents the half of the diagonal length of the imaging plane of the optical system, and f represents an effective focal length of the optical system. The optical system can be made to have an effective focal length which is smaller than an image field diameter (which is half of the diagonal length of the imaging plane), and have a longer depth of field range, which meets requirements on image definition.

In an implementation, the optical system satisfies the following expression: 0.13<TAN(FOV/2)/TTL<0.20; where TAN(FOV/2) represents a tangent of half of a field of view (FOV) of the optical system, and TTL represents a distance on the optical axis from an object-side surface of the first lens to an imaging plane of the optical system. The optical system structure can be miniaturized.

In an implementation, the optical system satisfies the following expression: 1<BFL<1.2; where BFL represents a minimum distance between an image-side surface of the seventh lens and the imaging surface in a direction parallel to the optical axis. It can ensure that the optical system has a sufficient focusing range, an assembly yield of the optical system can be improved. At the same time, it can ensure that the optical system has a large focal depth, and more depth information on the object side can be obtained.

In an implementation, the optical system satisfies the following expression: 1.5<TTL/f<2; where TTL represents a distance on the optical axis from an object-side surface of the first lens to the imaging plane of the optical system, and f represents an effective focal length of the optical system. In this way, the optical system is moderate in structure, a miniaturized design is satisfied, and performance parameters meet requirements.

In an implementation, the optical system satisfies the following expression: 0.85<ΣCT/f<1.2; where ΣCT represents a sum of a center thickness of each lens of the optical system on the optical axis, and f represents an effective focal length of the optical system. A compact structure combination of a lens group of the optical structure, a corresponding effective focal length, and a good manufacturability are ensured.

In an implementation, the optical system satisfies the following expression: 2<|R9+R10|/|R9−R10|<4.5; where R9 represents a radius of curvature of the object-side surface of the fourth lens, and R10 represents a radius of curvature of the image-side surface of the fourth lens. The radius of curvature of the object-side surface and the radius of curvature of the image-side surface of the fourth lens are relatively proper, and an incident angle can be appropriately reduced, which is beneficial to converging lights, reducing system sensitivity, and improving assembly stability.

In an implementation, the optical system satisfies the following expression: −3.5<f5/R12<−2; where f5 represents an effective focal length of the fifth lens, and R12 represents a radius of curvature of an image-side surface of the fifth lens. The fifth lens provides a positive refractive power to converge the lights, which is beneficial to reducing the total length of the optical system and achieving the miniaturization requirements.

In an implementation, the optical system satisfies the following expression: 1.7<|R11+R12|/R11×R12<2.2; where Ru represents a radius of curvature of an object-side surface of the fifth lens, and R12 represents a radius of curvature of an image-side surface of the fifth lens. The radius of curvature of the object-side surface and the radius of curvature of the image-side surface of the fifth lens are relatively proper, which can ensure the machinability of the fifth lens in shape, and can effectively reduce the aberration of the optical system.

In an implementation, the optical system satisfies the following expression: 0.7<ET15/CT15<1.2; where ET15 represents a center thickness of the seventh lens on a periphery, and CT15 represents a center thickness of the seventh lens on the optical axis. A good optical performance and molding yield can be ensured, and a good assembly stability can be satisfied at the same time.

In a second aspect, a lens module is further provided in the implementations of the present disclosure. The lens module includes a lens barrel, the optical system provided in any of the implementations in the first aspect. The first to seventh lenses of the optical system are received in the lens barrel. With each lens installed in the optical system, the lens module has characteristics of miniaturization and large wide-angle.

In a third aspect, an electronic device is further provided in the implementations of the present disclosure. The electronic device includes a housing, an electronic photosensitive element, the lens module provided in any of implementations in the second aspect. The lens module and the electronic photosensitive element are received in the housing. The electronic photosensitive element is disposed on an imaging plane of the optical system and configured to convert lights of an object passing through the first to seventh lenses and incidenting on the electronic photosensitive element into an electrical signal of an image. With the lens module arranged in the present disclosure, the electronic device can achieve thinness and miniaturization and a large wide-angle shooting.

### BRIEF DESCRIPTION OF THE DRAWINGS

To describe the technical solutions in the implementations of the present disclosure or the related art more clearly, the following briefly introduces the accompanying drawings required for describing the implementations or the related art. Apparently, the accompanying drawings in the following description illustrate some implementations of the present disclosure. Those of ordinary skill in the art may also obtain other drawings based on these accompanying drawings without creative efforts.

FIG. 1a is a schematic structural view of an optical system according to an implementation;

FIG. 1b illustrates a longitudinal spherical aberration curve of the optical system illustrated in FIG. 1a;

FIG. 1c illustrates an astigmatic field curve of the optical system illustrated in FIG. 1a;

FIG. 1d illustrates a distortion curve of the optical system illustrated in FIG. 1a;

FIG. 2a is a schematic structural view of an optical system according to an implementation;

FIG. 2b illustrates a longitudinal spherical aberration curve of the optical system illustrated in FIG. 2a;

FIG. 2c illustrates an astigmatic field curve of the optical system illustrated in FIG. 2a;

FIG. 2d illustrates a distortion curve of the optical system illustrated in FIG. 2a;

FIG. 3a is a schematic structural view of an optical system according to an implementation;

FIG. 3b illustrates a longitudinal spherical aberration curve of the optical system illustrated in FIG. 3a;

FIG. 3c illustrates an astigmatic field curve of the optical system illustrated in FIG. 3a;

FIG. 3d illustrates a distortion curve of the optical system illustrated in FIG. 3a;

FIG. 4a is a schematic structural view of an optical system according to an implementation;

FIG. 4b illustrates a longitudinal spherical aberration curve of the optical system illustrated in FIG. 4a;

FIG. 4c illustrates an astigmatic field curve of the optical system illustrated in FIG. 4a;

FIG. 4d illustrates a distortion curve of the optical system illustrated in FIG. 4a;

FIG. 5a is a schematic structural view of an optical system according to an implementation;

FIG. 5b illustrates a longitudinal spherical aberration curve of the optical system illustrated in FIG. 5a;

FIG. 5c illustrates an astigmatic field curve of the optical system illustrated in FIG. 5a;

FIG. 5d illustrates a distortion curve of the optical system illustrated in FIG. 5a;

FIG. 6a is a schematic structural view of an optical system according to an implementation;

FIG. 6b illustrates a longitudinal spherical aberration curve of the optical system illustrated in FIG. 6a;

FIG. 6c illustrates an astigmatic field curve of the optical system illustrated in FIG. 6a;

FIG. 6d illustrates a distortion curve of the optical system illustrated in FIG. 6a.

### DETAILED DESCRIPTION OF ILLUSTRATED IMPLEMENTATIONS

Technical solutions in the implementations of the present disclosure will be described clearly and completely hereinafter with reference to the accompanying drawings in the implementations of the present disclosure. Apparently, the described implementations are merely some rather than all implementations of the present disclosure. All other implementations obtained by those of ordinary skill in the art based on the implementations of the present disclosure without creative efforts shall fall within the protection scope of the present disclosure.

A lens module is provided. The lens module includes a lens barrel and an optical system provided in implementations of the disclosure. The first to seventh lenses of the optical system are received in the lens barrel. The lens module can be an independent lens of a digital camera or an imaging module integrated on an electronic device such as a smart phone. With the first to seventh lenses installed in the optical system, the lens module can achieve miniaturization and high-definition large scene shooting.

An electronic device is further provided. The electronic device includes a housing, an electronic photosensitive element, and the lens module in the implementations of the present disclosure. The lens module and the electronic photosensitive element are received in the housing. The electronic photosensitive element is disposed on an imaging plane of the optical system and configured to convert lights of an object passing through the first to seventh lenses and incidenting on the electronic photosensitive element into an electrical signal of an image. The electronic photosensitive element may be a complementary metal oxide semiconductor (CMOS) or a charge-coupled device (CCD). The electronic device can be a smart phone, a personal digital assistant (PDA), a tablet computer, a smart watch, a drone, etc. With the lens module arranged in the present disclosure, the electronic device can achieve miniaturization and high-definition large scene shooting.

The implementations of the present disclosure provide an optical system including, for example, seven lenses, namely, a first lens, a second lens, a third lens, a fourth lens, a fifth lens, a sixth lens, and a seventh lens. The first to seventh lenses are arranged in order from an object side to an image side along an optical axis of the optical system. In the first to seventh lenses, there is an air gap between any two adjacent lenses.

The first lens is with a positive refractive power or a negative refractive power. The second lens is with a positive refractive power or a negative refractive power. The second lens has an object-side surface which is convex and an image-side surface which is concave. The third lens is with a positive refractive power. The third lens has an image-side surface which is convex. The fourth lens is with a negative refractive power. The fourth lens has an object-side surface which is concave and an image-side surface which is convex. The fifth lens is with a positive refractive power. The sixth lens is with a negative refractive power. The seventh lens is with a positive refractive power or a negative refractive power.

The optical system further includes a stop. The stop can be arranged at any position between the first lens and the seventh lens, such as between the second lens and the third lens. The optical system satisfies the following expression: 1.2<Imgh/fno×L<1.4; where Imgh represents half of a diagonal length of an imaging plane of the optical system (specifically, Imgh may represent half of a diagonal length of an effective pixel area of an electronic photosensitive element on the imaging surface), fno represents an F-number of the optical system, and L represents an aperture of the stop. An appropriate configuration in a surface profile and a refractive power of each lens of the first to seventh lenses ensures that the optical system meets requirements of high-definition large-scale scene shooting. At the same time, an appropriate value of Imgh/fno×L can make a sufficient amount of light enter the optical system and make the optical system have a long depth of field, so that both distant and near objects can show clear shooting effect, which realizes high-definition large-scale scene shooting, and ensures shooting quality. If Imgh/fno×L>1.4, the amount of light entering the optical system will be insufficient, an image definition will be reduced, a shooting definition of a distant object cannot be ensured, it results in a decrease in an image definition, and a sufficient focusing range cannot be ensured. If Imgh/fnoxL<1.2, an image height will be insufficient, and requirements on image pixel cannot be ensured. At the same time, the field of view of image shooting is not large enough to meet requirements of large-scale scene shooting.

In an implementation, the first lens has an object-side surface which is concave at the optical axis and an image-side surface which is convex at the optical axis, and the object-side surface of the first lens is convex at a periphery of the object-side surface of the first lens and the image-side surface of the first lens is concave at a periphery of the image-side surface of the first lens, which can increase a field of view of the optical system.

In an implementation, the fifth lens has an object-side surface which is concave at the optical axis and an image-side surface which is convex at the optical axis, and the image-side surface of the fifth lens is concave at a periphery of the image-side surface of the fifth lens. The fifth lens converges lights, which is beneficial to reducing a total length of the optical system on the optical axis and realize miniaturization.

In an implementation, the sixth lens has an object-side surface which is convex at the optical axis and an image-side surface which is concave at the optical axis, and the seventh lens has an object-side surface which is convex at the optical axis and an image-side surface which is concave at the optical axis. The object-side surface of the sixth lens is concave at a periphery of the object-side surface of the sixth lens and the image-side surface of the sixth lens is convex at a periphery of the image-side surface of the sixth lens, and the object-side surface of the seventh lens is concave at a periphery of the object-side surface of the seventh lens and the image-side surface of the seventh lens is convex at a periphery of the image-side surface of the seventh lens. The configuration of the sixth lens is beneficial to a correction of chromatic aberration of the optical system.

In an implementation, the optical system satisfies the following expression: 1<D1/Imgh<1.4; where D1 represents a clear aperture diameter of the first lens. An aperture diameter of the first lens determines how much object space information can be acquired by the optical system. Therefore, an appropriate ratio of the aperture diameter of the first lens to an image height needs be satisfied. If D1/Imgh>1.4, the aperture is too large, which will not only increase a lens volume, but also make it difficult to correct an aberration of a subsequent lens combination. If D1/Imgh<1, the amount of light entering the optical system will be insufficient and the requirements of high-definition shooting cannot be satisfied.

In an implementation, the optical system satisfies the following expression: 2<D1/L<3.5; where D1 represents a clear aperture diameter of the first lens of the optical system. The aperture diameter of the first lens determines how much object space information can be acquired by the optical system. The stop is used to improve the optical performance. If D1/L>3.5, a volume of the optical system will be too large to meet the miniaturization design requirements, resulting in a difficulty in correction of the optical performance and aberration. If D1/L<2, it will result in insufficient acquisition of the object space information by the first lens, and the requirements of large-scale scene shooting cannot be satisfied. Therefore, an appropriate value of D1/L can meet miniaturization design requirements. At the same time, the optical performance is good, and the aberration correction is easy, which meets the requirements of large-scale scene shooting.

In an implementation, the optical system satisfies the following expression: 1.1<Imgh/f<1.3; where Imgh represents the half of the diagonal length of the imaging plane of the optical system, and f represents an effective focal length of the optical system. As such, the optical system can be made to have an effective focal length which is smaller than an image field diameter (which is half of the diagonal length of the imaging plane), and have a longer depth of field range, which meets requirements on image definition. If Imgh/f>1.3, it may cause insufficient shooting definition of distant scenes, which will affect the picture effect. If Imgh/f<1.1, the field of view will not be large enough to shoot large scenes.

In an implementation, the optical system satisfies the following expression: 90°<FOV<110°; where FOV represents an angle of view of the optical system. The field of view of the optical system is large, and large-area scenes can be shot, which meets the requirements of large-scale scene shooting. Compared with a common wide-angle lens with an angle of view of 60°-84°, the optical system in this implementation has a larger field of view, and can shoot large-area scenes to meet the requirements of large-scale scene shooting.

In an implementation, the optical system satisfies the following expression: 0.13<TAN(FOV/2)/TTL<0.20; where TAN(FOV/2) represents a tangent of half of a field of view (FOV) of the optical system, and TTL represents a distance on the optical axis from an object-side surface of the first lens to an imaging plane of the optical system. As such, the optical system structure can be miniaturized. If TAN(FOV/2)/TTL>0.20, the optical system is too compact in structure and aberration correction is difficult. If TAN(FOV/2)/TTL<0.13, the optical system is too long and does not meet the miniaturization design requirements.

In an implementation, the optical system satisfies the following expression: 1<BFL<1.2; where BFL represents a minimum distance between an image-side surface of the seventh lens and the imaging surface in a direction parallel to the optical axis. It can ensure that the optical system has a sufficient focusing range, an assembly yield of the optical system can be improved. At the same time, it can ensure that the optical system has a large focal depth, and more depth information on the object side can be obtained.

In an implementation, the optical system satisfies the following expression: 1.5<TTL/f<2; where TTL represents a distance on the optical axis from an object-side surface of the first lens to the imaging plane of the optical system, and f represents an effective focal length of the optical system. On the premise of satisfying a large wide-angle shooting, TTL/f determines a structural size of the entire optical system. When the above expression is satisfied, the optical system is moderate in structure, a miniaturized design is satisfied, and performance parameters meet requirements. If TTL/f≥2, the optical system is too long in structure to satisfy the miniaturization design. If TTL/f≤1.5, the optical system is too compact in structure, the performance parameters cannot meet the requirements, and aberration correction is difficult.

In an implementation, the optical system satisfies the following expression: 0.85<ΣCT/f<1.2; where ΣCT represents a sum of a center thickness of each lens of the optical system on the optical axis, and f represents an effective focal length of the optical system. Since each lens of the optical system is usually made of plastic, a focal position movement of the plastic lens with temperature changes will also increase, which may cause the optical lens group to be sensitive to tolerances. The expression in this implementation needs be satisfied, so as to ensure a compact structure combination of a lens group of the optical structure, a corresponding effective focal length, and a good manufacturability.

In an implementation, the optical system satisfies the following expression: 2<|R9+R10|/|R9−R10|<4.5; where R9 represents a radius of curvature of the object-side surface of the fourth lens, and R10 represents a radius of curvature of the image-side surface of the fourth lens. When the above expression is satisfied, the radius of curvature of the object-side surface and the radius of curvature of the image-side surface of the fourth lens are relatively proper, and an incident angle can be appropriately reduced, which is beneficial to converging lights, reducing system sensitivity, and improving assembly stability.

In an implementation, the optical system satisfies the following expression: −3.5<f5/R12<−2; where f5 represents an effective focal length of the fifth lens, and R12 represents a radius of curvature of an image-side surface of the fifth lens. The fifth lens provides a positive refractive power to converge the lights, which is beneficial to reducing the total length of the optical system and achieving the miniaturization requirements. When −3.5<f5/R12<−2 is satisfied, a positive refractive power can be ensured to reduce the total length of the optical system and meet the miniaturization design requirements.

In an implementation, the optical system satisfies the following expression: 1.7<|R11+R12|/R11×R12<2.2; where R11 represents a radius of curvature of an object-side surface of the fifth lens, and R12 represents a radius of curvature of an image-side surface of the fifth lens. When the above expression is satisfied, the radius of curvature of the object-side surface and the radius of curvature of the image-side surface of the fifth lens are relatively proper, which can ensure the machinability of the fifth lens in shape, and can effectively reduce the aberration of the optical system.

In an implementation, the optical system satisfies the following expression: 0.7<ET15/CT15<1.2; where ET15 represents a center thickness of the seventh lens on a periphery, and CT15 represents a center thickness of the seventh lens on the optical axis. The seventh lens is an aspherical lens, which is a key component for a final correction of the aberration and optical performance of the entire optical system. The processing difficulty is relatively high, and a ratio of the center thickness on a periphery to the center thickness on the optical axis should not be too large. When the processing technology satisfies 0.7<ET15/CT15<1.2, a good optical properties and molding yield can be ensured, and a good assembly stability can be satisfied at the same time.

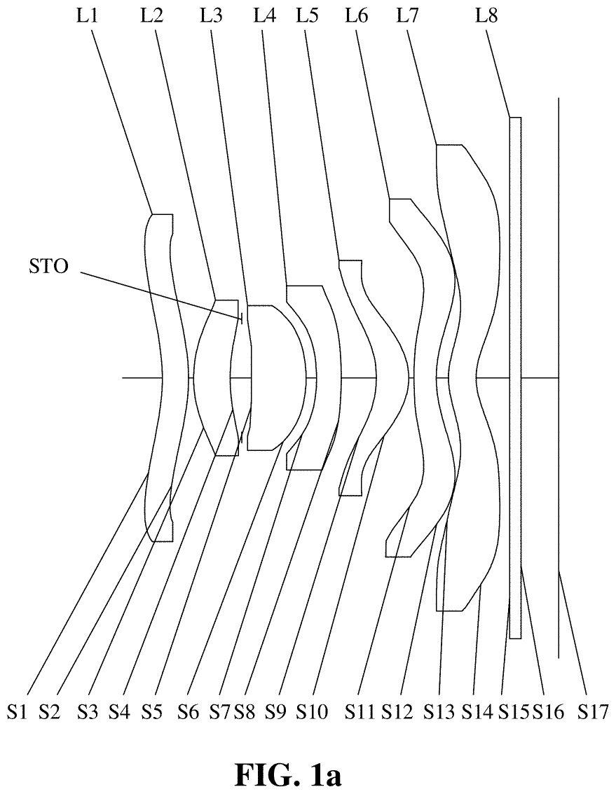

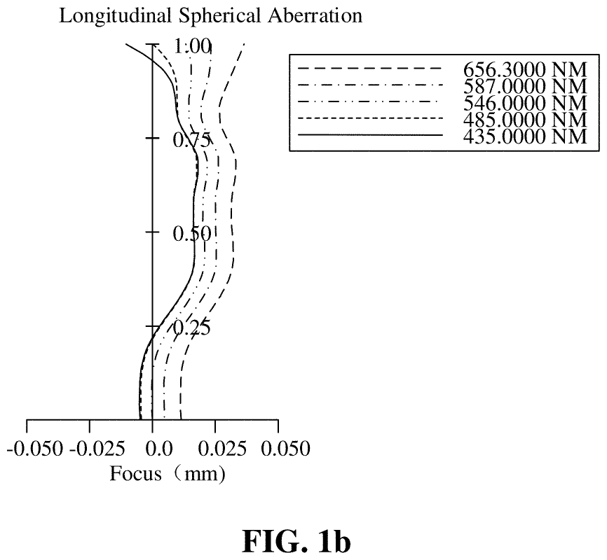

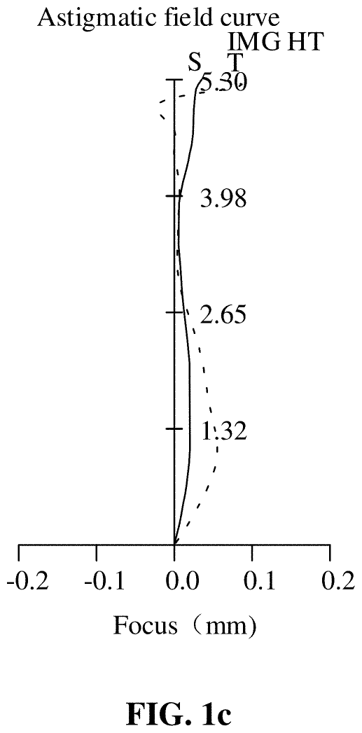

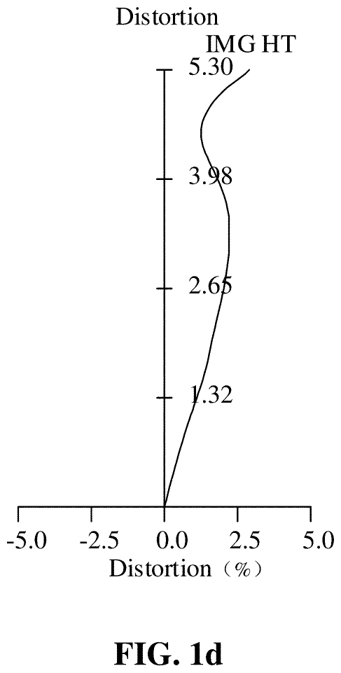

Referring to FIGS. 1a-1d, an optical system in this implementation includes, in order from an object side to an image side along an optical axis, a first lens L1, a second lens L2, a third lens L3, a fourth lens L4, a fifth lens L5, a sixth lens L6, and a seventh lens L7.

The first lens L1 has a positive refractive power. An object-side surface S1 of the first lens L1 is concave at the optical axis. An image-side surface S2 of the first lens L1 is convex at the optical axis. The object-side surface S1 of the first lens L1 is convex at a periphery of the object-side surface S1 of the first lens L1. The image-side surface S2 of the first lens L1 is concave at a periphery of the image-side surface S2 of the first lens L1.

The second lens L2 has a positive refractive power. An object-side surface S3 of the second lens L2 is convex (whether the object-side surface S3 is convex at the optical axis or at a periphery is not specified here, which means that the object-side surface S3 is convex at the optical axis as well as at the peripher, and the subsequent description refers to this description and will not be repeated). An image-side surface S4 of the second lens L2 is concave.

The third lens L3 has a positive refractive power. An object-side surface S5 of the third lens L3 is convex at the optical axis and is concave at a periphery of the object-side surface S5 of the third lens L3. An image-side surface S6 of the third lens L3 is convex.

The fourth lens L4 has a negative refractive power. An object-side surface S7 of the fourth lens L4 is concave. An image-side surface S8 of the fourth lens L4 is convex.

The fifth lens L5 has a positive refractive power. An object-side surface S9 of the fifth lens L5 is concave. An image-side surface S10 of the fifth lens L5 is convex at the optical axis and is concave at a periphery of the image-side surface S10 of the fifth lens L5.

The sixth lens L6 has a negative refractive power. An object-side surface S11 of the sixth lens L6 is convex at the optical axis and is concave at a periphery of the object-side surface S11 of the sixth lens L6. An image-side surface S12 of the sixth lens L6 is concave at the optical axis and is convex at a periphery of the image-side surface S12 of the sixth lens L6.

The seventh lens L7 has a negative refractive power. An object-side surface S13 of the seventh lens L7 is convex at the optical axis and is concave at a periphery of the object-side surface S13. An image-side surface S14 of the seventh lens L7 is concave at the optical axis and is convex at a periphery of the image-side surface S14 of the seventh lens L7.

In an implementation, each lens of the first to seventh lenses (L1 to L7) is made of plastic.

In addition, the optical system further includes a stop (STO), an infrared cut-off filter L8, and an imaging plane S17. The STO is arranged between the second lens L2 and the third lens L3, so as to control the amount of light entering the optical system and improve the performance of the optical system. In other implementations, the STO can also be disposed between two other adjacent lenses. The infrared cut-off filter L8 is disposed at an image side of the seventh lens L7 and has an object-side surface S15 and an image-side surface S16. The infrared cut-off filter L8 is used to filter out infrared light so that the light entering the imaging plane S17 is visible light, and the wavelength of visible light is 380 nm-780 nm. The infrared cut-off filter L8 is made of glass and can be coated thereon. The imaging plane S17 is an effective pixel area of the electronic photosensitive element.

Table 1a illustrates characteristics of the optical system in this implementation. Data in Table 1a is obtained based on light with a wavelength of 555 nm. Each of Y radius, thickness, and focal length is in units of millimeter (mm).

TABLE 1a
Optical System Illustrated in FIG. 1a
EFL = 4.34, FNO = 2, FOV = 99.66, TTL = 7.21

| Surface | Surface | Surface | | | | Refractive | Abbe | Focal |
|---|---|---|---|---|---|---|---|---|
| Number | Name | Type | Y Radius | Thickness | Material | Index | Number | length |
| OBJ | Object | Spherical | Infinity | Infinity | | | | |
| | surface | | | | | | | |
| S1 | First | Aspherical | −3.7330 | 0.4775 | Plastic | 1.55 | 56.11 | 63.76 |
| S2 | lens | Aspherical | −3.5243 | 0.0912 | | | | |
| S3 | Second | Aspherical | 2.3153 | 0.6641 | Plastic | 1.55 | 56.11 | 12.03 |
| S4 | lens | Aspherical | 3.2117 | 0.2117 | | | | |
| STO | Stop | Spherical | Infinity | 0.1762 | | | | |
| S5 | Third | Aspherical | 177.4726 | 0.9944 | Plastic | 1.55 | 56.11 | 4.66 |
| S6 | lens | Aspherical | −2.5768 | 0.1895 | | | | |
| S7 | Fourth | Aspherical | −3.3174 | 0.4510 | Plastic | 1.67 | 20.38 | −8.63 |
| S8 | lens | Aspherical | −8.2372 | 0.6376 | | | | |
| S9 | Fifth | Aspherical | −2.1183 | 0.5904 | Plastic | 1.59 | 28.32 | 3.69 |
| S10 | lens | Aspherical | −1.1876 | 0.0936 | | | | |
| S11 | Sixth | Aspherical | 9.7139 | 0.4060 | Plastic | 1.67 | 20.38 | −4.35 |
| S12 | lens | Aspherical | 2.2013 | 0.2230 | | | | |
| S13 | Seventh | Aspherical | 1.4114 | 0.5012 | Plastic | 1.55 | 56.11 | −50.81 |
| S14 | lens | Aspherical | 1.1746 | 0.6100 | | | | |
| S15 | Infrared | Spherical | Infinity | 0.2100 | Glass | | | |
| S16 | cut-off | Spherical | Infinity | 0.6815 | | | | |
| | filter | | | | | | | |
| S17 | Imaging | Spherical | Infinity | 0.0000 | | | | |
| | plane | | | | | | | |

Note:
The reference wavelength is 555 nm

In Table 1a, EFL represents an effective focal length of the optical system. FNO represents an F-number of the optical system. FOV represents an angle of view of the optical system.

In this implementation, the object-side surface and the image-side surface of each of the first to seventh lenses (L1, L2, L3, L4, L5, L6, L7) are aspherical. A surface shape of each aspherical lens can be defined by but not limited to the following aspherical formula:

$$x = \frac{{ch}^{2}}{1 + \sqrt{1 - ( k + 1 ) {c}^{2} {h}^{2}}} + \sum {Aih}^{i}$$

x represents a distance (sag) along the optical axis from a vertex of the aspherical surface to a position on the aspherical surface at a height h. c represents the paraxial curvature of the aspherical surface, and is the inverse of the Y radius (that is, c=1/R, where R represents the Y radius in the Table 1a). k represents the conic coefficient. Ai represents the i-th order correction coefficient of the aspherical surface. Table 1b shows higher-order coefficients A4, A6, A8, A10, A12, A14, A15, A17, and A18 of each of aspherical lens surfaces S1 to S14 of the optical system illustrated in FIG. 1a.

TABLE 1b

| Surface | | | | | | | | | | |
|---|---|---|---|---|---|---|---|---|---|---|
| Number | K | A4 | A6 | A8 | A10 | A12 | A14 | A15 | A17 | A18 |
| S1 | −7.68E+00 | 2.02E−02 | −1.04E−02 | 4.33E−03 | −1.22E−03 | 2.35E−04 | −3.03E−05 | 2.52E−06 | −1.21E−07 | 2.57E−09 |
| S2 | −5.88E+00 | 2.57E−02 | −1.65E−02 | 9.01E−03 | −3.40E−03 | 8.74E−04 | −1.50E−04 | 1.63E−05 | −1.02E−06 | 2.80E−08 |
| S3 | −3.74E+00 | 1.54E−02 | 1.10E−02 | −3.72E−02 | 4.65E−02 | −3.58E−02 | 1.78E−02 | −6.02E−03 | 1.31E−03 | −1.37E−04 |
| S4 | −1.35E+01 | 6.87E−03 | 4.79E−02 | −3.00E−01 | 8.95E−01 | −1.65E+00 | 1.89E+00 | −1.31E+00 | 5.08E−01 | −8.38E−02 |
| STO | 0.00E+00 | 0.00E+00 | 0.00E+00 | 0.00E+00 | 0.00E+00 | 0.00E+00 | 0.00E+00 | 0.00E+00 | 0.00E+00 | 0.00E+00 |
| S5 | −7.94E+03 | −1.21E−02 | −1.25E−01 | 6.75E−01 | −2.29E+00 | 4.62E+00 | −5.72E+00 | 4.24E+00 | −1.72E+00 | 2.95E−01 |
| S6 | −3.89E+00 | −9.47E−02 | 4.36E−02 | −5.11E−02 | 4.23E−02 | −3.76E−02 | 3.41E−02 | −2.28E−02 | 8.47E−03 | −1.30E−03 |
| S7 | −1.01E+01 | −1.33E−01 | 9.34E−02 | −9.42E−02 | 5.06E−02 | 6.69E−04 | −2.23E−02 | 1.65E−02 | −5.13E−03 | 5.77E−04 |
| S8 | −2.21E+00 | −4.96E−02 | 5.31E−02 | −4.05E−02 | 1.31E−02 | 2.01E−03 | −4.45E−03 | 2.12E−03 | −4.46E−04 | 3.55E−05 |
| S9 | −3.23E+00 | −1.59E−01 | 2.26E−01 | −2.10E−01 | 1.49E−01 | −7.40E−02 | 2.39E−02 | −4.74E−03 | 5.24E−04 | −2.48E−05 |
| S10 | −3.20E+00 | −1.16E−01 | 1.03E−01 | −7.84E−02 | 4.48E−02 | −1.50E−02 | 2.90E−03 | −3.13E−04 | 1.71E−05 | −3.39E−07 |
| S11 | −1.67E+01 | 9.44E−02 | −7.76E−02 | 3.03E−02 | −7.22E−03 | 9.86E−04 | −6.42E−05 | −1.78E−08 | 2.32E−07 | −8.90E−09 |
| S12 | −1.77E+01 | 7.67E−02 | −6.38E−02 | 2.54E−02 | −6.58E−03 | 1.13E−03 | −1.27E−04 | 8.88E−06 | −3.54E−07 | 6.10E−09 |
| S13 | −8.06E+00 | −3.19E−02 | −1.15E−02 | 6.78E−03 | −1.40E−03 | 1.60E−04 | −1.10E−05 | 4.57E−07 | −1.05E−08 | 1.04E−10 |
| S14 | −4.76E+00 | −3.79E−02 | 2.88E−03 | 1.10E−03 | −3.14E−04 | 3.79E−05 | −2.60E−06 | 1.04E−07 | −2.24E−09 | 1.99E−11 |

FIG. 1b illustrates a longitudinal spherical aberration curve of the optical system illustrated in FIG. 1a, and the longitudinal spherical aberration curve represents a focus deviation of each of light rays with different wavelengths after passing through each lens of the optical system. FIG. 1c illustrates an astigmatic field curve of the optical system illustrated in FIG. 1a, and the astigmatic field curve represents a tangential field curvature and a sagittal field curvature. FIG. 1d illustrates a distortion curve of the optical system illustrated in FIG. 1a, and the distortion curve represents magnitudes of distortions corresponding to different field angles. As illustrated in FIGS. 1b-1d, the optical system can achieve good imaging quality.

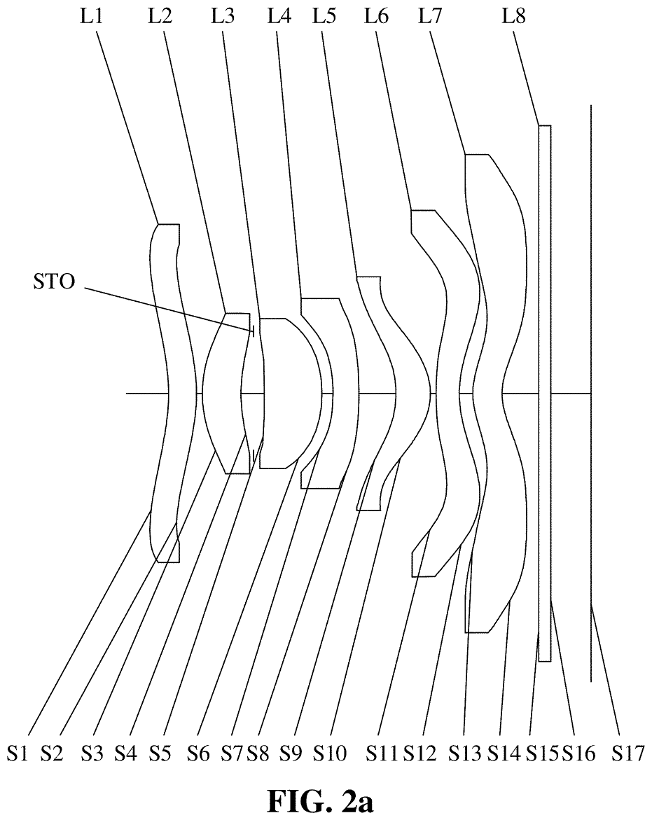

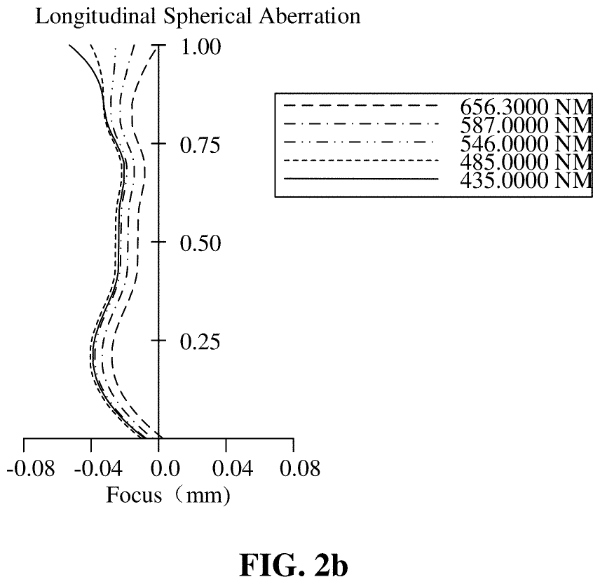

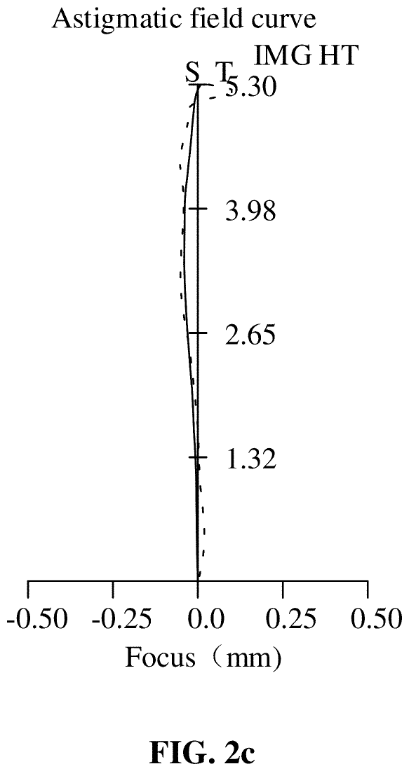

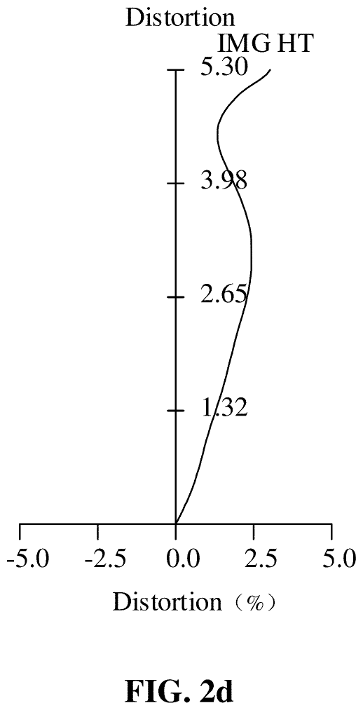

Referring to FIGS. 2a-2d, an optical system in this implementation includes, in order from an object side to an image side along an optical axis, a first lens L1, a second lens L2, a third lens L3, a fourth lens L4, a fifth lens L5, a sixth lens L6, and a seventh lens L7.

The first lens L1 has a positive refractive power. An object-side surface S1 of the first lens L1 is concave at the optical axis. An image-side surface S2 of the first lens L1 is convex at the optical axis. The object-side surface S1 of the first lens L1 is convex at a periphery of the object-side surface S1 of the first lens L1. The image-side surface S2 of the first lens L1 is concave at a periphery of the image-side surface S2 of the first lens L1.

The second lens L2 has a positive refractive power. An object-side surface S3 of the second lens L2 is convex. An image-side surface S4 of the second lens L2 is concave.

The third lens L3 has a positive refractive power. An object-side surface S5 of the third lens L3 is concave. An image-side surface S6 of the third lens L3 is convex.

The fourth lens L4 has a negative refractive power. An object-side surface S7 of the fourth lens L4 is concave. An image-side surface S8 of the fourth lens L4 is convex.

The fifth lens L5 has a positive refractive power. An object-side surface S9 of the fifth lens L5 is concave. An image-side surface S10 of the fifth lens L5 is convex at the optical axis and is concave at a periphery of the image-side surface S10 of the fifth lens L5.

The sixth lens L6 has a negative refractive power. An object-side surface S11 of the sixth lens L6 is convex at the optical axis and is concave at a periphery of the object-side surface S11 of the sixth lens L6. An image-side surface S12 of the sixth lens L6 is concave at the optical axis and is convex at a periphery of the image-side surface S12 of the sixth lens L6.

The seventh lens L7 has a positive refractive power. An object-side surface S13 of the seventh lens L7 is convex at the optical axis and is concave at a periphery of the object-side surface S13 of the seventh lens L7. An image-side surface S14 of the seventh lens L7 is concave at the optical axis and is convex at a periphery of the image-side surface S14 of the seventh lens L7.

The other structures of the optical system illustrated in FIG. 2a are identical with the optical system illustrated in FIG. 1a, reference can be made to the optical system illustrated in FIG. 1a.

Table 2a illustrates characteristics of the optical system in this implementation. Data in Table 2a is obtained based on light with a wavelength of 555 nm. Each of Y radius, thickness, and focal length is in units of millimeter (mm).

TABLE 2a
Optical System Illustrated in FIG. 2a
EFL = 4.41, FNO = 2, FOV = 98.98, TTL = 7.28

| Surface | Surface | Surface | | | | Refractive | Abbe | Focal |
|---|---|---|---|---|---|---|---|---|
| Number | Name | Type | Y Radius | Thickness | Material | Index | Number | length |
| Object | OBJ | Spherical | Infinity | Infinity | | | | |
| | surface | | | | | | | |
| S1 | First | Aspherical | −3.6889 | 0.4801 | Plastic | 1.55 | 56.11 | 62.48 |
| S2 | lens | Aspherical | −3.4823 | 0.1015 | | | | |
| S3 | Second | Aspherical | 2.3165 | 0.6666 | Plastic | 1.55 | 56.11 | 12.38 |
| S4 | lens | Aspherical | 3.1641 | 0.2141 | | | | |
| STO | Stop | Spherical | Infinity | 0.1845 | | | | |
| S5 | Third | Aspherical | −281.1849 | 0.9936 | Plastic | 1.55 | 56.11 | 4.74 |
| S6 | lens | Aspherical | −2.5726 | 0.1914 | | | | |
| S7 | Fourth | Aspherical | −3.3663 | 0.4466 | Plastic | 1.67 | 20.38 | −8.70 |
| S8 | lens | Aspherical | −8.4221 | 0.6373 | | | | |
| S9 | Fifth | Aspherical | −2.0954 | 0.5943 | Plastic | 1.59 | 28.32 | 3.76 |
| S10 | lens | Aspherical | −1.1928 | 0.1002 | | | | |
| S11 | Sixth | Aspherical | 9.4379 | 0.3975 | Plastic | 1.67 | 20.38 | −4.04 |
| S12 | lens | Aspherical | 2.0635 | 0.2330 | | | | |
| S13 | Seventh | Aspherical | 1.3073 | 0.5039 | Plastic | 1.55 | 56.11 | 71.72 |
| S14 | lens | Aspherical | 1.1682 | 0.6286 | | | | |
| S15 | Infrared | Spherical | Infinity | 0.2100 | Glass | | | |
| S16 | cut-off | Spherical | Infinity | 0.6972 | | | | |
| | filter | | | | | | | |
| S17 | Imaging | Spherical | Infinity | 0.0000 | | | | |
| | plane | | | | | | | |

Note:
The reference wavelength is 555 nm

In Table 2a, EFL represents an effective focal length of the optical system. FNO represents an F-number of the optical system. FOV represents an angle of view of the optical system.

Table 2b shows higher-order coefficients that can be used for each aspherical lens of the optical system illustrated in FIG. 2a, where a shape of each aspherical lens surface can be defined by the formula given for the optical system illustrated in FIG. 1a.

TABLE 2b

| Surface | | | | | | | | | | |
|---|---|---|---|---|---|---|---|---|---|---|
| Number | K | A4 | A6 | A8 | A10 | A12 | A14 | A15 | A17 | A18 |
| S1 | −7.70E+00 | 2.00E−02 | −9.98E−03 | 4.03E−03 | −1.12E−03 | 2.15E−04 | −2.81E−05 | 2.40E−06 | −1.19E−07 | 2.62E−09 |
| S2 | −5.85E+00 | 2.55E−02 | −1.62E−02 | 8.68E−03 | −3.23E−03 | 8.30E−04 | −1.44E−04 | 1.59E−05 | −1.02E−06 | 2.85E−08 |
| S3 | −3.74E+00 | 1.93E−02 | −4.93E−03 | −3.79E−03 | 1.62E−03 | 3.37E−03 | −4.09E−03 | 1.52E−03 | −1.44E−04 | −1.55E−05 |
| S4 | −1.34E+01 | 1.64E−03 | 1.09E−01 | −6.11E−01 | 1.78E+00 | −3.16E+00 | 3.50E+00 | −2.35E+00 | 8.77E−01 | −1.40E−01 |
| STO | 0.00E+00 | 0.00E+00 | 0.00E+00 | 0.00E+00 | 0.00E+00 | 0.00E+00 | 0.00E+00 | 0.00E+00 | 0.00E+00 | 0.00E+00 |
| S5 | −2.03E+11 | −7.77E−03 | −1.66E−01 | 8.64E−01 | −2.78E+00 | 5.38E+00 | −6.43E+00 | 4.61E+00 | −1.82E+00 | 3.05E−01 |
| S6 | −3.90E+00 | −9.89E−02 | 6.49E−02 | −1.15E−01 | 1.67E−01 | −1.95E−01 | 1.62E−01 | −8.64E−02 | 2.62E−02 | −3.42E−03 |
| S7 | −1.02E+01 | −1.32E−01 | 8.28E−02 | −5.29E−02 | −3.65E−02 | 1.08E−01 | −1.01E−01 | 5.06E−02 | −1.31E−02 | 1.35E−03 |
| S8 | −1.72E+00 | −4.92E−02 | 4.82E−02 | −2.71E−02 | −5.65E−03 | 1.71E−02 | −1.16E−02 | 4.10E−03 | −7.45E−04 | 5.43E−05 |
| S9 | −3.30E+00 | −1.56E−01 | 2.13E−01 | −1.85E−01 | 1.26E−01 | −6.16E−02 | 2.00E−02 | −4.03E−03 | 4.54E−04 | −2.19E−05 |
| S10 | −3.20E+00 | −1.11E−01 | 8.34E−02 | −4.86E−02 | 2.18E−02 | −4.83E−03 | 1.69E−04 | 1.22E−04 | −2.11E−05 | 1.08E−06 |
| S11 | −1.71E+01 | 9.30E−02 | −7.69E−02 | 3.10E−02 | −7.83E−03 | 1.21E−03 | −1.09E−04 | 4.85E−06 | −5.24E−08 | −2.04E−09 |
| S12 | −1.71E+01 | 7.60E−02 | −6.33E−02 | 2.54E−02 | −6.64E−03 | 1.15E−03 | −1.30E−04 | 9.15E−06 | −3.66E−07 | 6.30E−09 |
| S13 | −7.47E+00 | −1.14E−02 | 6.59E−03 | −3.08E−02 | −1.35E−03 | 1.54E−04 | −1.05E−05 | 4.35E−07 | −9.99E−09 | 9.84E−11 |
| S14 | −4.79E+00 | −3.75E−02 | 2.32E−03 | 1.28E−03 | −3.42E−04 | 4.06E−05 | −2.75E−06 | 1.09E−07 | −2.34E−09 | 2.08E−11 |

FIG. 2b illustrates a longitudinal spherical aberration curve of the optical system illustrated in FIG. 2a, and the longitudinal spherical aberration curve represents a focus deviation of each of light rays with different wavelengths after passing through each lens of the optical system. FIG. 2c illustrates an astigmatic field curve of the optical system illustrated in FIG. 2a, and the astigmatic field curve represents a tangential field curvature and a sagittal field curvature. FIG. 2d illustrates a distortion curve of the optical system illustrated in FIG. 2a, and the distortion curve represents magnitudes of distortions corresponding to different field angles. As illustrated in FIGS. 2b-2d, the optical system illustrated in FIG. 2a can achieve good imaging quality.

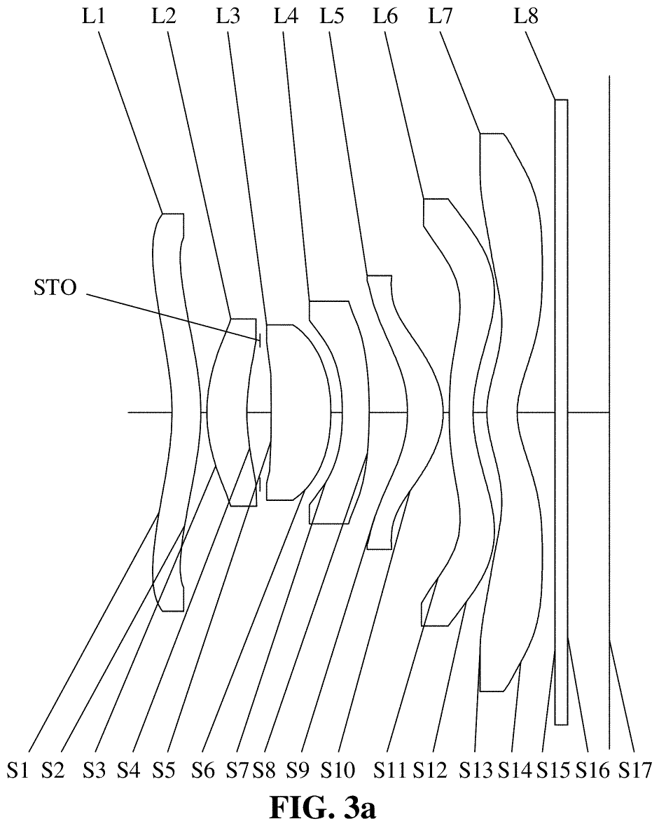

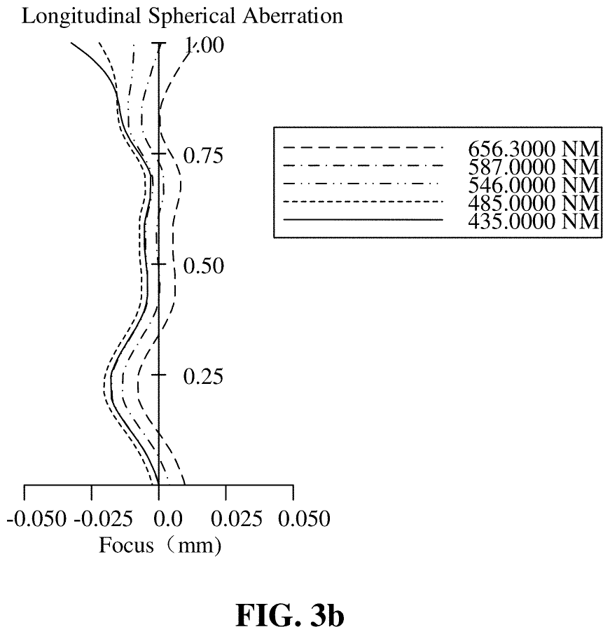

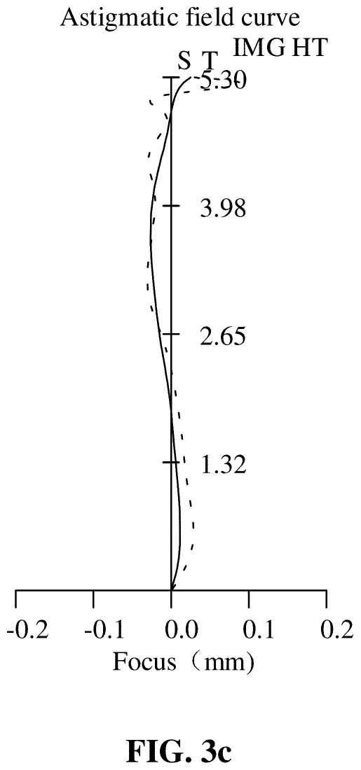

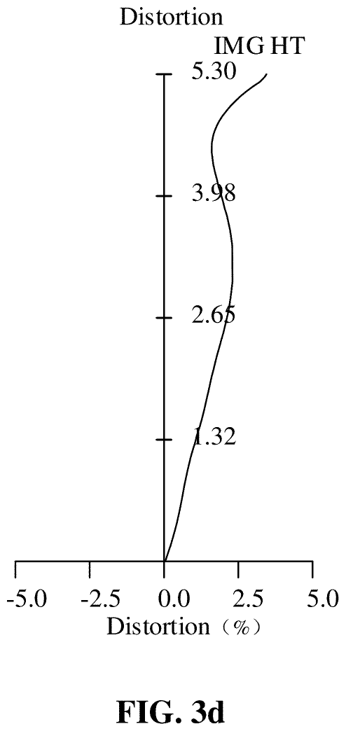

Referring to FIGS. 3a-3d, an optical system in this implementation includes, in order from an object side to an image side along an optical axis, a first lens L1, a second lens L2, a third lens L3, a fourth lens L4, a fifth lens L5, a sixth lens L6, and a seventh lens L7.

The first lens L1 has a positive refractive power. An object-side surface S1 of the first lens L1 is concave at the optical axis. An image-side surface S2 of the first lens L1 is convex at the optical axis. The object-side surface S1 of the first lens L1 is convex at a periphery of the object-side surface S1 of the first lens L1. The image-side surface S2 of the first lens L1 is concave at a periphery of the image-side surface S2 of the first lens L1.

The second lens L2 has a positive refractive power. An object-side surface S3 of the second lens L2 is convex. An image-side surface S4 of the second lens L2 is concave.

The third lens L3 has a positive refractive power. An object-side surface S5 of the third lens L3 is convex at the optical axis and is concave at a periphery of the object-side surface S5 of the third lens L3. An image-side surface S6 of the third lens L3 is convex.

The fourth lens L4 has a negative refractive power. An object-side surface S7 of the fourth lens L4 is concave. An image-side surface S8 of the fourth lens L4 is convex.

The fifth lens L5 has a positive refractive power. An object-side surface S9 of the fifth lens L5 is concave. An image-side surface S10 of the fifth lens L5 is convex at the optical axis and is concave at a periphery of the image-side surface S10 of the fifth lens L5.

The sixth lens L6 has a negative refractive power. An object-side surface S11 of the sixth lens L6 is convex at the optical axis and is concave at a periphery of the object-side surface S11 of the sixth lens L6. An image-side surface S12 of the sixth lens L6 is concave at the optical axis and is convex at a periphery of the image-side surface S12 of the sixth lens L6.

The seventh lens L7 has a positive refractive power. An object-side surface S13 of the seventh lens L7 is convex at the optical axis and is concave at a periphery of the object-side surface S13 of the seventh lens L7. An image-side surface S14 of the seventh lens L7 is concave at the optical axis and is convex at a periphery of the image-side surface S14 of the seventh lens L7.

The other structures of the optical system illustrated in FIG. 3a are identical with the optical system illustrated in FIG. 1a, reference can be made to the optical system illustrated in FIG. 1a.

Table 3a illustrates characteristics of the optical system in this implementation. Data in Table 3a is obtained based on light with a wavelength of 555 nm. Each of Y radius, thickness, and focal length is in units of millimeter (mm).

TABLE 3a
Optical System Illustrated in FIG. 3a
EFL = 4.37 , FNO = 2, FOV = 98.92, TTL = 7.29

| Surface | Surface | Surface | | | | Refractive | Abbe | Focal |
|---|---|---|---|---|---|---|---|---|
| Number | Name | Type | Y Radius | Thickness | Material | Index | Number | length |
| Object | OBJ | Spherical | Infinity | Infinity | | | | |
| | surface | | | | | | | |
| S1 | First | Aspherical | −3.6850 | 0.4805 | Plastic | 1.55 | 56.11 | 62.45 |
| S2 | lens | Aspherical | −3.4792 | 0.1007 | | | | |
| S3 | Second | Aspherical | 2.3143 | 0.6675 | Plastic | 1.55 | 56.11 | 12.38 |
| S4 | lens | Aspherical | 3.1589 | 0.2154 | | | | |
| STO | Stop | Spherical | Infinity | 0.1869 | | | | |
| S5 | Third | Aspherical | 225.1345 | 0.9966 | Plastic | 1.55 | 56.11 | 4.66 |
| S6 | lens | Aspherical | −2.5700 | 0.1918 | | | | |
| S7 | Fourth | Aspherical | −3.3844 | 0.4466 | Plastic | 1.67 | 20.38 | −8.68 |
| S8 | lens | Aspherical | −8.5510 | 0.6386 | | | | |
| S9 | Fifth | Aspherical | −2.0935 | 0.5942 | Plastic | 1.59 | 28.32 | 3.75 |
| S10 | lens | Aspherical | −1.1917 | 0.1022 | | | | |
| S11 | Sixth | Aspherical | 9.5529 | 0.3955 | Plastic | 1.67 | 20.38 | −3.96 |
| S12 | lens | Aspherical | 2.0389 | 0.2306 | | | | |
| S13 | Seventh | Aspherical | 1.3056 | 0.5062 | Plastic | 1.55 | 56.11 | 62.73 |
| S14 | lens | Aspherical | 1.1713 | 0.6296 | | | | |
| S15 | Infrared | Spherical | Infinity | 0.2100 | Glass | | | |
| S16 | cut-off | Spherical | Infinity | 0.6983 | | | | |
| | filter | | | | | | | |
| S17 | Imaging | Spherical | Infinity | 0 | | | | |
| | plane | | | | | | | |

Note:
The reference wavelength is 555 nm

In Table 3a, EFL represents an effective focal length of the optical system. FNO represents an F-number of the optical system. FOV represents an angle of view of the optical system.

Table 3b shows higher-order coefficients that can be used for each aspherical lens of the optical system illustrated in FIG. 3a, where a shape of each aspherical lens surface can be defined by the formula given for the optical system illustrated in FIG. 1a.

TABLE 3b

| Surface | | | | | | | | | | |
|---|---|---|---|---|---|---|---|---|---|---|
| Number | K | A4 | A6 | A8 | A10 | A12 | A14 | A15 | A17 | A18 |
| S1 | −7.70E+00 | 2.00E−02 | −1.00E−02 | 4.03E−03 | −1.11E−03 | 2.14E−04 | −2.81E−05 | 2.40E−06 | −1.20E−07 | 2.65E−09 |
| S2 | −5.84E+00 | 2.55E−02 | −1.63E−02 | 8.75E−03 | −3.27E−03 | 8.41E−04 | −1.46E−04 | 1.63E−05 | −1.05E−06 | 2.94E−08 |
| S3 | −3.74E+00 | 1.98E−02 | −7.82E−03 | 4.46E−03 | −1.24E−02 | 1.82E−02 | −1.39E−02 | 5.49E−03 | −1.04E−03 | 7.18E−05 |
| S4 | −1.34E+01 | 4.49E−04 | 1.22E−01 | −6.79E−01 | 1.98E+00 | −3.52E+00 | 3.90E+00 | −2.62E+00 | 9.79E−01 | −1.56E−01 |
| STO | 0.00E+00 | 0.00E+00 | 0.00E+00 | 0.00E+00 | 0.00E+00 | 0.00E+00 | 0.00E+00 | 0.00E+00 | 0.00E+00 | 0.00E+00 |
| S5 | −3.15E+25 | −7.43E−03 | −1.76E−01 | 9.34E−01 | −3.04E+00 | 5.95E+00 | −7.19E+00 | 5.22E+00 | −2.09E+00 | 3.53E−01 |
| S6 | −3.90E+00 | −9.91E−02 | 6.47E−02 | −1.09E−01 | 1.43E−01 | −1.50E−01 | 1.15E−01 | −5.90E−02 | 1.77E−02 | −2.32E−03 |
| S7 | −1.02E+01 | −1.33E−01 | 8.79E−02 | −6.69E−02 | −1.46E−02 | 8.70E−02 | −8.87E−02 | 4.60E−02 | −1.22E−02 | 1.28E−03 |
| S8 | −1.71E+00 | −4.98E−02 | 5.04E−02 | −3.10E−02 | −1.55E−03 | 1.44E−02 | −1.05E−02 | 3.83E−03 | −7.05E−04 | 5.18E−05 |
| S9 | −3.31E+00 | −1.56E−01 | 2.11E−01 | −1.82E−01 | 1.23E−01 | −5.99E−02 | 1.94E−02 | −3.89E−03 | 4.38E−04 | −2.11E−05 |
| S10 | −3.20E+00 | −1.12E−01 | 8.73E−02 | −5.22E−02 | 2.36E−02 | −5.38E−03 | 2.75E−04 | 1.09E−04 | −2.01E−05 | 1.05E−06 |
| S11 | −1.76E+01 | 9.15E−02 | −7.46E−02 | 2.94E−02 | −7.28E−03 | 1.10E−03 | −9.34E−05 | 3.69E−06 | −4.34E−09 | −2.85E−09 |
| S12 | −1.69E+01 | 7.57E−02 | −6.26E−02 | 2.50E−02 | −6.52E−03 | 1.13E−03 | −1.28E−04 | 9.04E−06 | −3.62E−07 | 6.24E−09 |
| S13 | −7.36E+00 | −3.07E−02 | −1.15E−02 | 6.61E−03 | −1.36E−03 | 1.54E−04 | −1.06E−05 | 4.37E−07 | −1.01E−08 | 9.93E−11 |
| S14 | −4.79E+00 | −3.72E−02 | 2.00E−03 | 1.38E−03 | −3.59E−04 | 4.24E−05 | −2.87E−06 | 1.14E−07 | −2.47E−09 | 2.21E−11 |

FIG. 3b illustrates a longitudinal spherical aberration curve of the optical system illustrated in FIG. 3a, and the longitudinal spherical aberration curve represents a focus deviation of each of light rays with different wavelengths after passing through each lens of the optical system. FIG. 3c illustrates an astigmatic field curve of the optical system illustrated in FIG. 3a, and the astigmatic field curve represents a tangential field curvature and a sagittal field curvature. FIG. 3d illustrates a distortion curve of the optical system illustrated in FIG. 3a, and the distortion curve represents magnitudes of distortions corresponding to different field angles. As illustrated in FIGS. 3b-3d, the optical system illustrated in FIG. 3a can achieve good imaging quality.

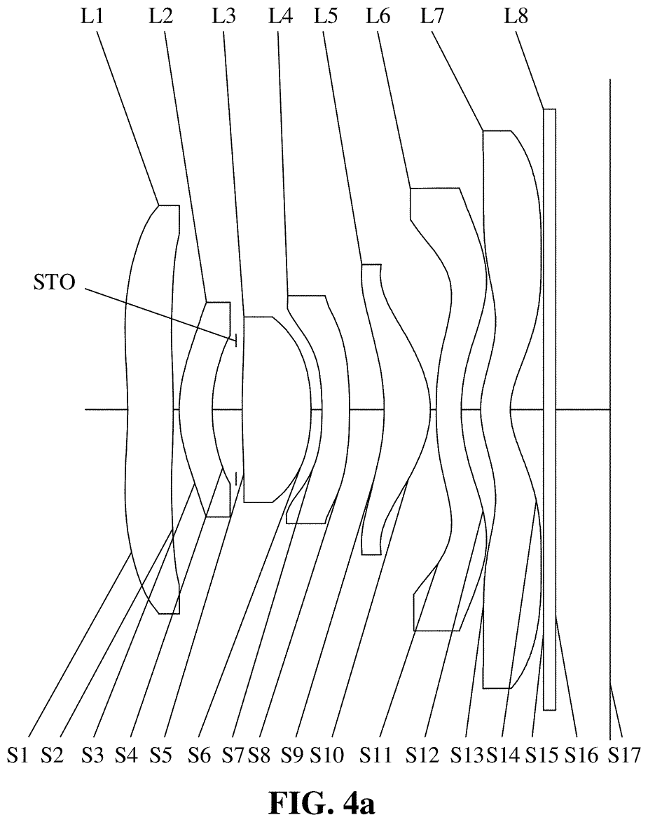

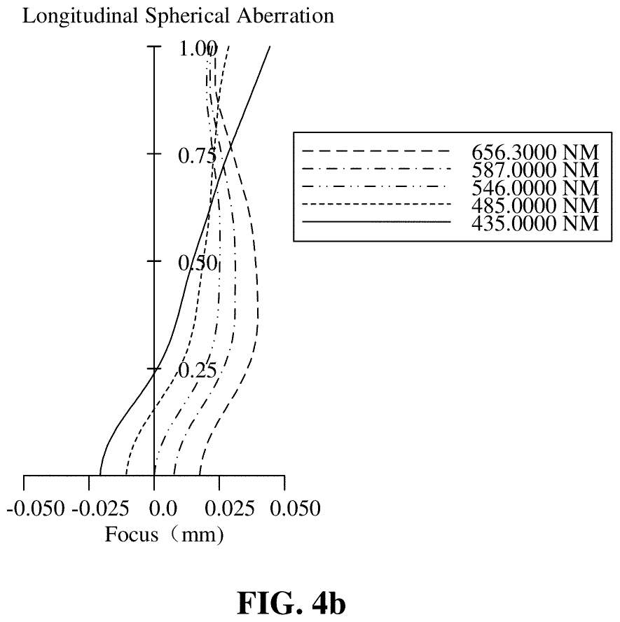

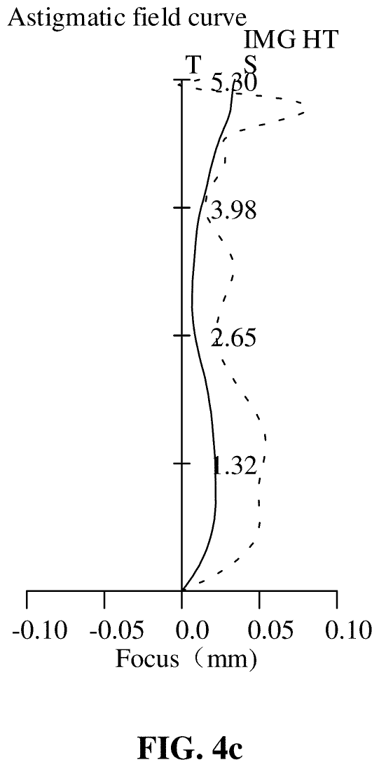

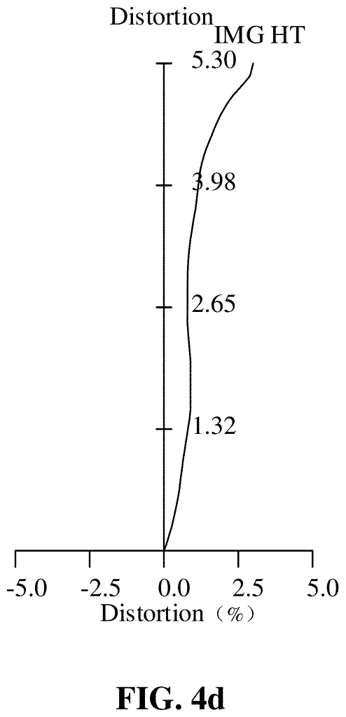

Referring to FIGS. 4a-4d, an optical system in this implementation includes, in order from an object side to an image side along an optical axis, a first lens L1, a second lens L2, a third lens L3, a fourth lens L4, a fifth lens L5, a sixth lens L6, and a seventh lens L7.

The first lens L1 has a negative refractive power. An object-side surface S1 of the first lens L1 is concave at the optical axis. An image-side surface S2 of the first lens L1 is convex at the optical axis. The object-side surface S1 of the first lens L1 is convex at a periphery of the image-side surface S2 of the first lens L1. The image-side surface S2 of the first lens L1 is concave at a periphery of the image-side surface S2 of the first lens L1.

The second lens L2 has a positive refractive power. An object-side surface S3 of the second lens L2 is convex. An image-side surface S4 of the second lens L2 is concave.

The third lens L3 has a positive refractive power. An object-side surface S5 of the third lens L3 is convex at the optical axis and is concave at a periphery of the object-side surface S5 of the third lens L3. An image-side surface S6 of the third lens L3 is convex of the image-side surface S6 of the third lens L3.

The fourth lens L4 has a negative refractive power. An object-side surface S7 of the fourth lens L4 is concave. An image-side surface S8 of the fourth lens L4 is convex.

The fifth lens L5 has a positive refractive power. An object-side surface S9 of the fifth lens L5 is concave at the optical axis and is convex at a perphery. An image-side surface S10 of the fifth lens L5 is convex at the optical axis and is concave at a periphery of the image-side surface S10 of the fifth lens L5.

The sixth lens L6 has a negative refractive power. An object-side surface S11 of the sixth lens L6 is convex at the optical axis and is concave at a periphery of the object-side surface S11 of the sixth lens L6. An image-side surface S12 of the sixth lens L6 is concave at the optical axis and is convex at a periphery of the image-side surface S12 of the sixth lens L6.

The seventh lens L7 has a negative refractive power. An object-side surface S13 of the seventh lens L7 is convex at the optical axis and is concave at a periphery of the object-side surface S13 of the seventh lens L7. An image-side surface S14 of the seventh lens L7 is concave at the optical axis and is convex at a periphery of the image-side surface S14 of the seventh lens L7.

The other structures of the optical system illustrated in FIG. 4a are identical with the optical system illustrated in FIG. 1a, reference can be made to the optical system illustrated in FIG. 1a.

Table 4a illustrates characteristics of the optical system in this implementation. Data in Table 4a is obtained based on light with a wavelength of 555 nm. Each of Y radius, thickness, and focal length is in units of millimeter (mm).

TABLE 4a
Optical System Illustrated in FIG. 4a
EFL = 4.21, FNO = 2, FOV = 101.26, TTL = 8.17

| Surface | Surface | Surface | | | | Refractive | Abbe | Focal |
|---|---|---|---|---|---|---|---|---|
| Number | Name | Type | Y Radius | Thickness | Material | Index | Number | length |
| OBJ | Object | Spherical | Infinity | Infinity | | | | |
| | surface | | | | | | | |
| S1 | First | Aspherical | −7.3678 | 0.7717 | Plastic | 1.55 | 56.11 | −54.55 |
| S2 | lens | Aspherical | −10.1486 | 0.1000 | | | | |
| S3 | Second | Aspherical | 2.2164 | 0.5589 | Plastic | 1.59 | 28.32 | 27.60 |
| S4 | lens | Aspherical | 2.3235 | 0.4079 | | | | |
| STO | Stop | Spherical | Infinity | 0.1006 | | | | |
| S5 | Third | Aspherical | 15.0454 | 1.1673 | Plastic | 1.55 | 56.11 | 4.79 |
| S6 | lens | Aspherical | −3.0796 | 0.1854 | | | | |
| S7 | Fourth | Aspherical | −4.6345 | 0.4657 | Plastic | 1.68 | 19.24 | −17.06 |
| S8 | lens | Aspherical | −8.0341 | 0.5855 | | | | |
| S9 | Fifth | Aspherical | −3.6114 | 0.7823 | Plastic | 1.55 | 56.11 | 3.92 |
| S10 | lens | Aspherical | −1.4487 | 0.1000 | | | | |
| S11 | Sixth | Aspherical | 7.5288 | 0.4235 | Plastic | 1.65 | 23.52 | −6.33 |
| S12 | lens | Aspherical | 2.5908 | 0.3290 | | | | |
| S13 | Seventh | Aspherical | 1.3781 | 0.5032 | Plastic | 1.55 | 56.11 | −18.62 |
| S14 | lens | Aspherical | 1.0571 | 0.5592 | | | | |
| S15 | Infrared | Spherical | Infinity | 0.2100 | Glass | | | |
| S16 | cut-off | Spherical | Infinity | 0.9238 | | | | |
| | filter | | | | | | | |
| S17 | Imaging | Spherical | Infinity | 0.0000 | | | | |
| | plane | | | | | | | |

Note:
The reference wavelength is 555 nm

In Table 4a, EFL represents an effective focal length of the optical system. FNO represents an F-number of the optical system. FOV represents an angle of view of the optical system.

Table 4b shows higher-order coefficients that can be used for each aspherical lens of the optical system illustrated in FIG. 4a, where a shape of each aspherical lens surface can be defined by the formula given for the optical system illustrated in FIG. 1a.

TABLE 4b

| Surface | | | | | | | | | | |
|---|---|---|---|---|---|---|---|---|---|---|
| Number | K | A4 | A6 | A8 | A10 | A12 | A14 | A15 | A17 | A18 |
| S1 | −7.51E+00 | 3.50E−02 | −1.17E−02 | 3.77E−03 | −9.75E−04 | 1.85E−04 | −2.43E−05 | 2.04E−06 | −9.77E−08 | 2.02E−09 |
| S2 | −1.07E+01 | 3.15E−02 | −1.39E−02 | 5.11E−03 | −1.37E−03 | 2.50E−04 | −3.02E−05 | 2.37E−06 | −1.14E−07 | 2.66E−09 |
| S3 | −5.64E+00 | 2.98E−02 | −1.67E−02 | −1.10E−02 | 2.13E−02 | −1.63E−02 | 7.09E−03 | −1.73E−03 | 2.17E−04 | −1.07E−05 |
| S4 | −6.84E+00 | 4.51E−02 | −6.18E−02 | 2.13E−01 | −5.66E−01 | 9.50E−01 | −9.86E−01 | 6.16E−01 | −2.13E−01 | 3.13E−02 |
| STO | 0.00E+00 | 0.00E+00 | 0.00E+00 | 0.00E+00 | 0.00E+00 | 0.00E+00 | 0.00E+00 | 0.00E+00 | 0.00E+00 | 0.00E+00 |
| S5 | −3.15E+01 | −1.08E−03 | 5.36E−03 | −4.93E−02 | 1.25E−01 | −1.72E−01 | 1.30E−01 | −5.15E−02 | 7.69E−03 | 3.59E−04 |
| S6 | −4.81E+00 | −8.38E−02 | 3.80E−02 | −6.13E−02 | 6.90E−02 | −5.05E−02 | 2.15E−02 | −4.20E−03 | −9.58E−05 | 1.15E−04 |
| S7 | −1.25E+01 | −1.07E−01 | 8.02E−02 | −1.49E−01 | 1.76E−01 | −1.37E−01 | 7.01E−02 | −2.19E−02 | 3.79E−03 | −2.81E−04 |
| S8 | −1.25E+01 | −4.68E−02 | 5.35E−02 | −7.24E−02 | 5.96E−02 | −3.30E−02 | 1.23E−02 | −2.88E−03 | 3.89E−04 | −2.32E−05 |
| S9 | −6.64E+00 | −7.37E−02 | 1.14E−01 | −9.09E−02 | 4.74E−02 | −1.69E−02 | 4.07E−03 | −6.18E−04 | 5.33E−05 | −1.98E−06 |
| S10 | −5.40E+00 | −1.19E−01 | 1.13E−01 | −7.65E−02 | 3.64E−02 | −1.13E−02 | 2.29E−03 | −2.89E−04 | 2.07E−05 | −6.46E−07 |
| S11 | −7.46E+00 | 7.62E−02 | −4.46E−02 | 1.00E−02 | −5.23E−04 | −3.07E−04 | 8.32E−05 | −9.50E−06 | 5.35E−07 | −1.22E−08 |
| S12 | −2.38E+01 | 9.42E−02 | −5.99E−02 | 1.94E−02 | −4.11E−03 | 5.77E−04 | −5.27E−05 | 2.99E−06 | −9.58E−08 | 1.32E−09 |
| S13 | −6.22E+00 | −3.65E−02 | −8.86E−03 | 5.69E−03 | −1.16E−03 | 1.31E−04 | −8.97E−06 | 3.74E−07 | −8.71E−09 | 8.73E−11 |
| S14 | −3.51E+00 | −4.86E−02 | 8.82E−03 | −1.04E−03 | 1.23E−04 | −1.44E−05 | 1.21E−06 | −6.07E−08 | 1.64E−09 | −1.83E−11 |

FIG. 4b illustrates a longitudinal spherical aberration curve of the optical system illustrated in FIG. 4a, and the longitudinal spherical aberration curve represents a focus deviation of each of light rays with different wavelengths after passing through each lens of the optical system. FIG. 4c illustrates an astigmatic field curve of the optical system illustrated in FIG. 4a, and the astigmatic field curve represents a tangential field curvature and a sagittal field curvature. FIG. 4d illustrates a distortion curve of the optical system illustrated in FIG. 4a, and the distortion curve represents magnitudes of distortions corresponding to different field angles. As illustrated in FIGS. 4b-4d, the optical system illustrated in FIG. 4a can achieve good imaging quality.

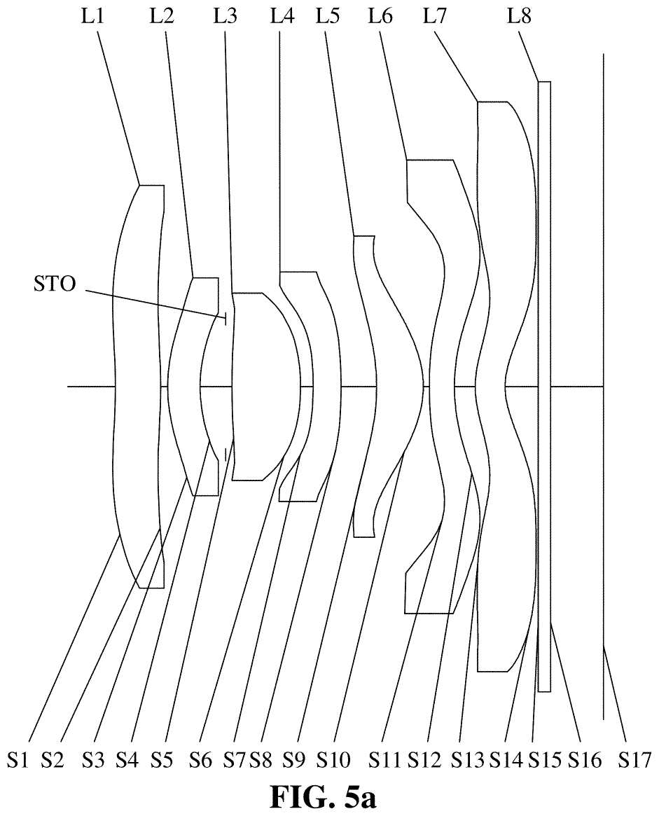

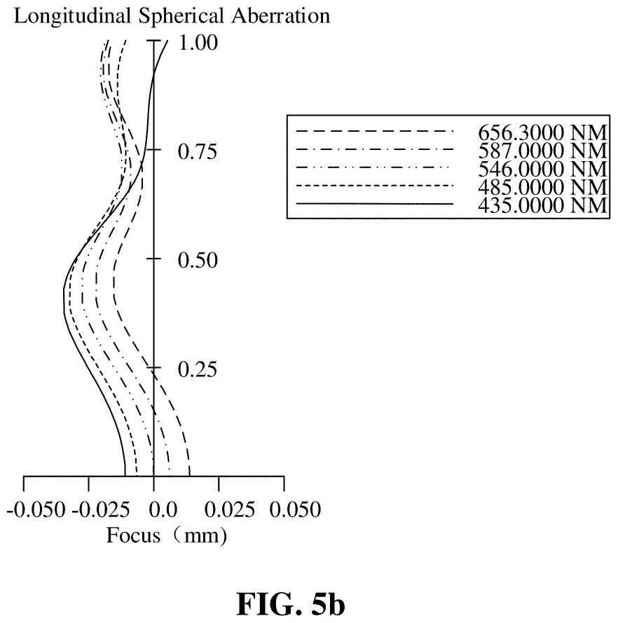

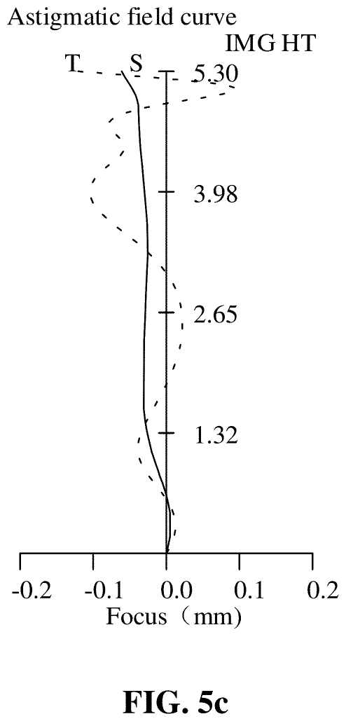

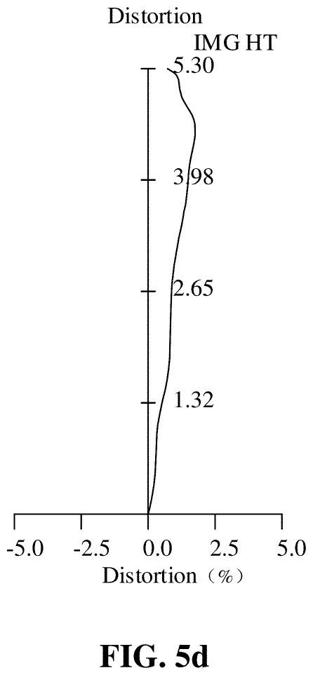

Referring to FIGS. 5a-5d, an optical system in this implementation includes, in order from an object side to an image side along an optical axis, a first lens L1, a second lens L2, a third lens L3, a fourth lens L4, a fifth lens L5, a sixth lens L6, and a seventh lens L7.

The first lens L1 has a positive refractive power. An object-side surface S1 of the first lens L1 is concave at the optical axis. An image-side surface S2 of the first lens L1 is convex at the optical axis. The object-side surface S1 of the first lens L1 is convex at a periphery of the object-side surface S1 of the first lens L1. The image-side surface S2 of the first lens L1 is concave at a periphery of the image-side surface S2 of the first lens L1.

The second lens L2 has a negative refractive power. An object-side surface S3 of the second lens L2 is convex. An image-side surface S4 of the second lens L2 is concave.

The third lens L3 has a positive refractive power. An object-side surface S5 of the third lens L3 is convex. An image-side surface S6 of the third lens L3 is convex.

The fourth lens L4 has a negative refractive power. An object-side surface S7 of the fourth lens L4 is concave. An image-side surface S8 of the fourth lens L4 is convex.

The fifth lens L5 has a positive refractive power. An object-side surface S9 of the fifth lens L5 is concave at the optical axis and is convex at a perphery. An image-side surface S10 of the fifth lens L5 is convex at the optical axis and is concave at a periphery of the image-side surface S10 of the fifth lens L5.

The sixth lens L6 has a negative refractive power. An object-side surface S11 of the sixth lens L6 is convex at the optical axis and is concave at a periphery of the object-side surface S11 of the sixth lens L6. An image-side surface S12 of the sixth lens L6 is concave at the optical axis and is convex at a periphery of the image-side surface S12 of the sixth lens L6.

The seventh lens L7 has a negative refractive power. An object-side surface S13 of the seventh lens L7 is convex at the optical axis and is concave at a periphery of the object-side surface S13 of the seventh lens L7. An image-side surface S14 of the seventh lens L7 is concave at the optical axis and is convex at a periphery of the image-side surface S14 of the seventh lens L7.

The other structures of the optical system illustrated in FIG. 5a are identical with the optical system illustrated in FIG. 1a, reference can be made to the optical system illustrated in FIG. 1a.

Table 5a illustrates characteristics of the optical system in this implementation. Data in Table 5a is obtained based on light with a wavelength of 555 nm. Each of Y radius, thickness, and focal length is in units of millimeter (mm).

TABLE 5a
Optical System Illustrated in FIG. 5a
EFL = 4.32, FNO = 2.1, FOV = 101.3, TTL = 8.37

| Surface | Surface | Surface | | | | Refractive | Abbe | Focal |
|---|---|---|---|---|---|---|---|---|
| Number | Name | Type | Y Radius | Thickness | Material | Index | Number | length |
| OBJ | Object | Spherical | Infinity | Infinity | | | | |
| | surface | | | | | | | |
| S1 | First | Aspherical | −7.3812 | 0.7758 | Plastic | 1.55 | 56.11 | 505.06 |
| S2 | lens | Aspherical | −7.4560 | 0.1216 | | | | |
| S3 | Second | Aspherical | 2.4299 | 0.5565 | Plastic | 1.59 | 28.32 | −245.41 |
| S4 | lens | Aspherical | 2.1864 | 0.4390 | | | | |
| STO | Stop | Spherical | Infinity | 0.1061 | | | | |
| S5 | Third | Aspherical | 11.0874 | 1.1774 | Plastic | 1.55 | 56.11 | 4.55 |
| S6 | lens | Aspherical | −3.0878 | 0.2167 | | | | |
| S7 | Fourth | Aspherical | −4.8655 | 0.4787 | Plastic | 1.68 | 19.24 | −19.57 |
| S8 | lens | Aspherical | −7.9774 | 0.6092 | | | | |
| S9 | Fifth | Aspherical | −3.5025 | 0.8017 | Plastic | 1.55 | 56.11 | 4.04 |
| S10 | lens | Aspherical | −1.4646 | 0.1040 | | | | |
| S11 | Sixth | Aspherical | 7.6164 | 0.4299 | Plastic | 1.65 | 23.52 | −6.77 |
| S12 | lens | Aspherical | 2.7147 | 0.3579 | | | | |
| S13 | Seventh | Aspherical | 1.4433 | 0.5125 | Plastic | 1.55 | 56.11 | −14.34 |
| S14 | lens | Aspherical | 1.0659 | 0.5671 | | | | |
| S15 | Infrared | Spherical | Infinity | 0.2100 | Glass | | | |
| S16 | cut-off | Spherical | Infinity | 0.9096 | | | | |
| | filter | | | | | | | |
| S17 | Imaging | Spherical | Infinity | 0.0000 | | | | |
| | plane | | | | | | | |

Note: The reference wavelength is 555 nm

In Table 5a, EFL represents an effective focal length of the optical system. FNO represents an F-number of the optical system. FOV represents an angle of view of the optical system.

Table 5b shows higher-order coefficients that can be used for each aspherical lens of the optical system illustrated in FIG. 5a, where a shape of each aspherical lens surface can be defined by the formula given for the optical system illustrated in FIG. 1a.

TABLE 5b

| Surface | | | | | | | | | | |
|---|---|---|---|---|---|---|---|---|---|---|
| Number | K | A4 | A6 | A8 | A10 | A12 | A14 | A15 | A17 | A18 |
| S1 | −1.19E+01 | 3.09E−02 | −8.97E−03 | 2.49E−03 | −5.66E−04 | 9.83E−05 | −1.22E−05 | 9.84E−07 | −4.57E−08 | 9.14E−10 |
| S2 | −4.28E+01 | 3.08E−02 | −1.52E−02 | 6.10E−03 | −1.79E−03 | 3.59E−04 | −4.79E−05 | 4.11E−06 | −2.07E−07 | 4.69E−09 |
| S3 | −5.96E+00 | 4.00E−02 | −7.30E−02 | 1.06E−01 | −1.21E−01 | 9.45E−02 | −4.81E−02 | 1.52E−02 | −2.70E−03 | 2.05E−04 |
| S4 | −6.59E+00 | 4.98E−02 | −9.99E−02 | 3.32E−01 | −7.45E−01 | 1.05E+00 | −9.09E−01 | 4.49E−01 | −1.09E−01 | 8.66E−03 |
| STO | 0.00E+00 | 0.00E+00 | 0.00E+00 | 0.00E+00 | 0.00E+00 | 0.00E+00 | 0.00E+00 | 0.00E+00 | 0.00E+00 | 0.00E+00 |
| S5 | −1.84E+02 | 1.40E−02 | −2.11E−02 | 6.20E−02 | −2.16E−01 | 4.81E−01 | −6.46E−01 | 5.04E−01 | −2.11E−01 | 3.64E−02 |
| S6 | −4.78E+00 | −7.91E−02 | 1.35E−02 | 3.33E−02 | −1.24E−01 | 1.80E−01 | −1.45E−01 | 6.73E−02 | −1.70E−02 | 1.81E−03 |
| S7 | −1.31E+01 | −9.49E−02 | 3.45E−02 | −5.68E−02 | 7.04E−02 | −5.98E−02 | 3.47E−02 | −1.26E−02 | 2.59E−03 | −2.32E−04 |
| S8 | −1.03E+01 | −3.86E−02 | 2.77E−02 | −3.37E−02 | 2.46E−02 | −1.25E−02 | 4.44E−03 | −1.03E−03 | 1.40E−04 | −8.63E−06 |
| S9 | −6.64E+00 | −6.42E−02 | 9.05E−02 | −6.51E−02 | 3.15E−02 | −1.09E−02 | 2.62E−03 | −4.03E−04 | 3.54E−05 | −1.33E−06 |
| S10 | −5.38E+00 | −1.15E−01 | 1.06E−01 | −7.12E−02 | 3.46E−02 | −1.12E−02 | 2.38E−03 | −3.15E−04 | 2.35E−05 | −7.55E−07 |
| S11 | −8.05E+00 | 7.42E−02 | −4.26E−02 | 9.66E−03 | −7.21E−04 | −1.80E−04 | 5.20E−05 | −5.46E−06 | 2.65E−07 | −4.86E−09 |
| S12 | −2.33E+01 | 9.25E−02 | −5.76E−02 | 1.83E−02 | −3.82E−03 | 5.32E−04 | −4.83E−05 | 2.74E−06 | −8.80E−08 | 1.22E−09 |
| S13 | −6.20E+00 | −3.54E−02 | −8.91E−03 | 5.41E−03 | −1.06E−03 | 1.13E−04 | −7.35E−06 | 2.88E−07 | −6.28E−09 | 5.85E−11 |
| S14 | −3.50E+00 | −4.66E−02 | 8.04E−03 | −8.94E−04 | 1.06E−04 | −1.30E−05 | 1.10E−06 | −5.57E−08 | 1.50E−09 | −1.67E−11 |

FIG. 5b illustrates a longitudinal spherical aberration curve of the optical system illustrated in FIG. 5a, and the longitudinal spherical aberration curve represents a focus deviation of each of light rays with different wavelengths after passing through each lens of the optical system. FIG. 5c illustrates an astigmatic field curve of the optical system illustrated in FIG. 5a, and the astigmatic field curve represents a tangential field curvature and a sagittal field curvature. FIG. 5d illustrates a distortion curve of the optical system illustrated in FIG. 5a, and the distortion curve represents magnitudes of distortions corresponding to different field angles. As illustrated in FIGS. 5b-5d, the optical system illustrated in FIG. 5a can achieve good imaging quality.

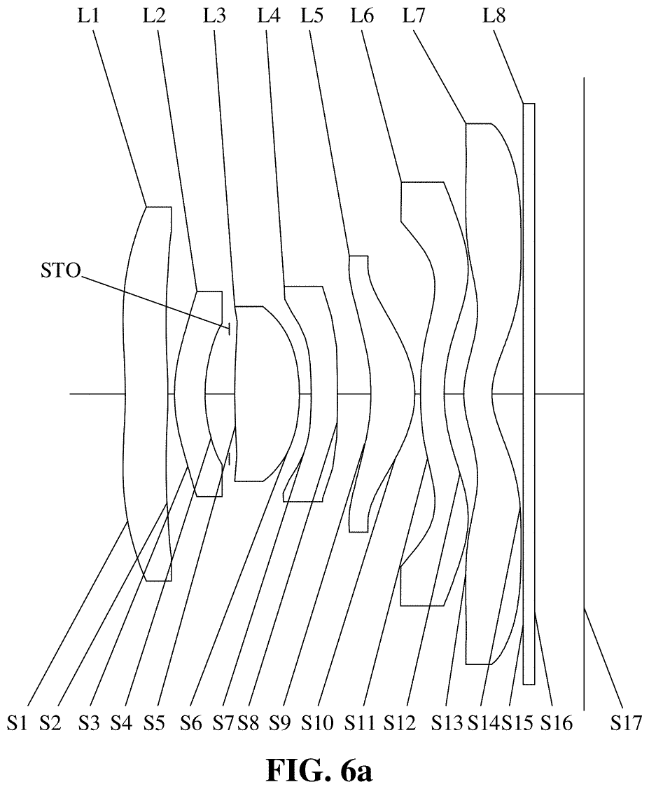

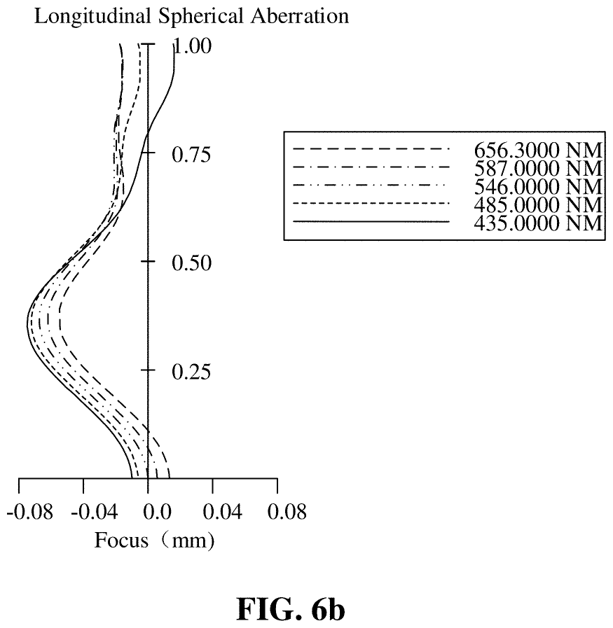

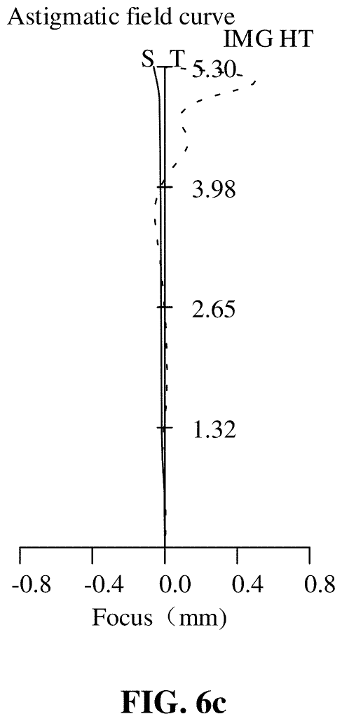

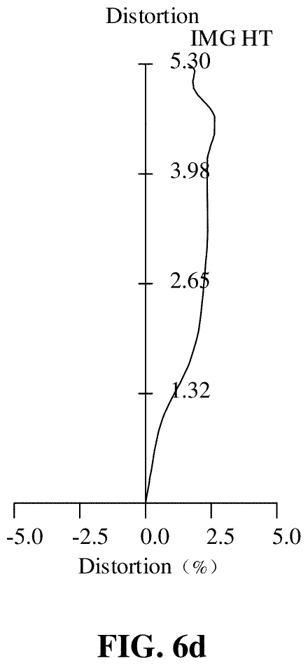

Referring to FIGS. 6a-6d, an optical system in this implementation includes, in order from an object side to an image side along an optical axis, a first lens L1, a second lens L2, a third lens L3, a fourth lens L4, a fifth lens L5, a sixth lens L6, and a seventh lens L7.

The first lens L1 has a negative refractive power. An object-side surface S1 of the first lens L1 is concave at the optical axis. An image-side surface S2 of the first lens L1 is convex at the optical axis. The object-side surface S1 of the first lens L1 is convex at a periphery of the object-side surface S1 of the first lens L1. The image-side surface S2 of the first lens L1 is concave at a periphery of the image-side surface S2 of the first lens L1.

The second lens L2 has a negative refractive power. An object-side surface S3 of the second lens L2 is convex. An image-side surface S4 of the second lens L2 is concave.

The third lens L3 has a positive refractive power. An object-side surface S5 of the third lens L3 is convex. An image-side surface S6 of the third lens L3 is convex.

The fourth lens L4 has a negative refractive power. An object-side surface S7 of the fourth lens L4 is concave. An image-side surface S8 of the fourth lens L4 is convex.

The fifth lens L5 has a positive refractive power. An object-side surface S9 of the fifth lens L5 is concave. An image-side surface S10 of the fifth lens L5 is convex at the optical axis and is concave at a periphery of the image-side surface S10 of the fifth lens L5.

The sixth lens L6 has a negative refractive power. An object-side surface S11 of the sixth lens L6 is convex at the optical axis and is concave at a periphery of the object-side surface S11 of the sixth lens L6. An image-side surface S12 of the sixth lens L6 is concave at the optical axis and is convex at a periphery of the image-side surface S12 of the sixth lens L6.

The seventh lens L7 has a negative refractive power. An object-side surface S13 of the seventh lens L7 is convex at the optical axis and is concave at a periphery of the object-side surface S13 of the seventh lens L7. An image-side surface S14 of the seventh lens L7 is concave at the optical axis and is convex at a periphery of the image-side surface S14 of the seventh lens L7.

The other structures of the optical system illustrated in FIG. 6a are identical with the optical system illustrated in FIG. 1a, reference can be made to the optical system illustrated in FIG. 1a.

Table 6a illustrates characteristics of the optical system in this implementation. Data in Table 6a is obtained based on light with a wavelength of 555 nm. Each of Y radius, thickness, and focal length is in units of millimeter (mm).

TABLE 6a
Optical System Illustrated in FIG. 6a
EFL = 4.30, FNO = 2.1, FOV = 101.2, TTL = 8.28

| Surface | Surface | Surface | | | | Refractive | Abbe | Focal |
|---|---|---|---|---|---|---|---|---|
| Number | Name | Type | Y Radius | Thickness | Material | Index | Number | length |
| OBJ | Object | Spherical | Infinity | Infinity | | | | |
| | surface | | | | | | | |
| S1 | First | Aspherical | −7.7769 | 0.7678 | Plastic | 1.55 | 56.11 | −699.47 |
| S2 | lens | Aspherical | −8.2154 | 0.1204 | | | | |
| S3 | Second | Aspherical | 2.6447 | 0.5510 | Plastic | 1.59 | 28.32 | −280.22 |
| S4 | lens | Aspherical | 2.4014 | 0.4347 | | | | |
| STO | Stop | Spherical | Infinity | 0.1000 | | | | |
| S5 | Third | Aspherical | 11.2445 | 1.1657 | Plastic | 1.55 | 56.11 | 4.53 |
| S6 | lens | Aspherical | −3.0605 | 0.2145 | | | | |
| S7 | Fourth | Aspherical | −9.7480 | 0.4739 | Plastic | 1.68 | 19.24 | −18.64 |
| S8 | lens | Aspherical | −43.1622 | 0.6032 | | | | |
| S9 | Fifth | Aspherical | −3.4492 | 0.7937 | Plastic | 1.55 | 56.11 | 4.03 |
| S10 | lens | Aspherical | −1.4534 | 0.1030 | | | | |
| S11 | Sixth | Aspherical | 7.4533 | 0.4256 | Plastic | 1.65 | 23.52 | −6.75 |
| S12 | lens | Aspherical | 2.6878 | 0.3543 | | | | |
| S13 | Seventh | Aspherical | 1.4290 | 0.5074 | Plastic | 1.55 | 56.11 | −14.20 |
| S14 | lens | Aspherical | 1.0553 | 0.5615 | | | | |
| S15 | Infrared | Spherical | Infinity | 0.2100 | Glass | | | |
| S16 | cut-off | Spherical | Infinity | 0.8901 | | | | |
| | filter | | | | | | | |
| S17 | Imaging | Spherical | Infinity | 0.0000 | | | | |
| | plane | | | | | | | |

Note:
The reference wavelength is 555 nm

In Table 6a, EFL represents an effective focal length of the optical system. FNO represents an F-number of the optical system. FOV represents an angle of view of the optical system.

Table 6b shows higher-order coefficients that can be used for each aspherical lens of the optical system illustrated in FIG. 6a, where a shape of each aspherical lens surface can be defined by the formula given for the optical system illustrated in FIG. 1a.

TABLE 6b

| Surface | | | | | | | | | | |
|---|---|---|---|---|---|---|---|---|---|---|
| Number | K | A4 | A6 | A8 | A10 | A12 | A14 | A15 | A17 | A18 |
| S1 | −1.70E+01 | 3.00E−02 | −8.80E−03 | 2.52E−03 | −5.76E−04 | 9.69E−05 | −1.13E−05 | 8.49E−07 | −3.67E−08 | 6.89E−10 |
| S2 | −7.52E+01 | 3.09E−02 | −1.59E−02 | 6.54E−03 | −1.96E−03 | 4.00E−04 | −5.45E−05 | 4.77E−06 | −2.45E−07 | 5.67E−09 |
| S3 | −5.96E+00 | 5.28E−02 | −1.25E−01 | 2.10E−01 | −2.52E−01 | 1.97E−01 | −9.91E−02 | 3.07E−02 | −5.30E−03 | 3.91E−04 |
| S4 | −6.59E+00 | 3.28E−02 | −5.82E−02 | 4.04E−01 | −1.44E+00 | 2.82E+00 | −3.19E+00 | 2.09E+00 | −7.40E−01 | 1.09E−01 |
| STO | 0.00E+00 | 0.00E+00 | 0.00E+00 | 0.00E+00 | 0.00E+00 | 0.00E+00 | 0.00E+00 | 0.00E+00 | 0.00E+00 | 0.00E+00 |
| S5 | −1.11E+02 | 1.05E−02 | −2.07E−02 | 6.69E−02 | −2.40E−01 | 5.49E−01 | −7.56E−01 | 6.04E−01 | −2.58E−01 | 4.57E−02 |
| S6 | −4.78E+00 | −8.64E−02 | 1.07E−02 | 4.06E−02 | −1.34E−01 | 1.87E−01 | −1.46E−01 | 6.61E−02 | −1.63E−02 | 1.70E−03 |
| S7 | −1.31E+01 | −9.19E−02 | 2.73E−02 | −6.03E−02 | 8.25E−02 | −7.04E−02 | 4.04E−02 | −1.47E−02 | 3.06E−03 | −2.81E−04 |
| S8 | −1.03E+01 | −2.80E−02 | 6.50E−03 | −2.09E−02 | 2.26E−02 | −1.35E−02 | 5.08E−03 | −1.20E−03 | 1.66E−04 | −1.04E−05 |
| S9 | −6.64E+00 | −6.61E−02 | 9.47E−02 | −6.91E−02 | 3.40E−02 | −1.19E−02 | 2.91E−03 | −4.57E−04 | 4.09E−05 | −1.58E−06 |
| S10 | −5.38E+00 | −1.21E−01 | 1.18E−01 | −8.60E−02 | 4.46E−02 | −1.53E−02 | 3.40E−03 | −4.67E−04 | 3.60E−05 | −1.19E−06 |
| S11 | −8.05E+00 | 7.65E−02 | −4.48E−02 | 1.04E−02 | −7.88E−04 | −2.01E−04 | 5.92E−05 | −6.34E−06 | 3.14E−07 | −5.88E−09 |
| S12 | −2.33E+01 | 9.53E−02 | −6.05E−02 | 1.96E−02 | −4.18E−03 | 5.94E−04 | −5.50E−05 | 3.18E−06 | −1.04E−07 | 1.47E−09 |
| S13 | −6.20E+00 | −3.50E−02 | −1.04E−02 | 6.08E−03 | −1.19E−03 | 1.29E−04 | −8.47E−06 | 3.36E−07 | −7.44E−09 | 7.07E−11 |
| S14 | −3.50E+00 | −4.80E−02 | 8.44E−03 | −9.59E−04 | 1.16E−04 | −1.44E−05 | 1.26E−06 | −6.47E−08 | 1.78E−09 | −2.02E−11 |

FIG. 6b illustrates a longitudinal spherical aberration curve of the optical system illustrated in FIG. 6a, and the longitudinal spherical aberration curve represents a focus deviation of each of light rays with different wavelengths after passing through each lens of the optical system. FIG. 6c illustrates an astigmatic field curve of the optical system illustrated in FIG. 6a, and the astigmatic field curve represents a tangential field curvature and a sagittal field curvature. FIG. 6d illustrates a distortion curve of the optical system illustrated in FIG. 6a, and the distortion curve represents magnitudes of distortions corresponding to different field angles. As illustrated in FIGS. 6b-6d, the optical system illustrated in FIG. 6a can achieve good imaging quality.

Table 7 illustrates a refractive power of each lens of the optical system illustrated in any one of FIG. 1a, FIG. 2a, FIG. 3a, FIG. 4a, FIG. 5a, and FIG. 6a.

TABLE 7

| | L1 | L2 | L3 | L4 | L5 | L6 | L7 |
|---|---|---|---|---|---|---|---|
| Optical System of FIG. 1a | Positive | Positive | Positive | Negative | Positive | Negative | Negative |
| Optical System of FIG. 2a | Positive | Positive | Positive | Negative | Positive | Negative | Positive |
| Optical System of FIG. 3a | Positive | Positive | Positive | Negative | Positive | Negative | Positive |
| Optical System of FIG. 4a | Negative | Positive | Positive | Negative | Positive | Negative | Negative |
| Optical System of FIG. 5a | Positive | Negative | Positive | Negative | Positive | Negative | Negative |
| Optical System of FIG. 6a | Negative | Negative | Positive | Negative | Positive | Negative | Negative |

Table 8 illustrates a surface profile of each lens of the optical system illustrated in any one of FIG. 1a, FIG. 2a, FIG. 3a, FIG. 4a, FIG. 5a, and FIG. 6a at the optical axis.

TABLE 8

| | L1 | L2 | L3 | L4 | L5 | L6 | L7 | |
|---|---|---|---|---|---|---|---|---|
| FIG. 1a | ) ) | ( ( | ( ) | ) ) | ) ) | ( ( | ( ( | At |
| | Concave | Convex | Convex | Concave | Concave | Convex | Convex | Optical |
| | Convex | Concave | Convex | Convex | Convex | Concave | Concave | Axis |
| FIG. 2a | ) ) | ( ( | ) ) | ) ) | ) ) | ( ( | ( ( | |
| | Concave | Convex | Concave | Concave | Concave | Convex | Convex | |
| | Convex | Concave | Convex | Convex | Convex | Concave | Concave | |
| FIG. 3a | ) ) | ( ( | ( ) | ) ) | ) ) | ( ( | ( ( | |
| | Concave | Convex | Convex | Concave | Concave | Convex | Convex | |
| | Convex | Concave | Convex | Convex | Convex | Concave | Concave | |
| FIG. 4a | ) ) | ( ( | ( ) | ) ) | ) ) | ( ( | ( ( | |
| | Concave | Convex | Convex | Concave | Concave | Convex | Convex | |
| | Convex | Concave | Convex | Convex | Convex | Concave | Concave | |
| FIG. 5a | ) ) | ( ( | ( ) | ) ) | ) ) | ( ( | ( ( | |
| | Concave | Convex | Convex | Concave | Concave | Convex | Convex | |
| | Convex | Concave | Convex | Convex | Convex | Concave | Concave | |
| FIG. 6a | ) ) | ( ( | ( ) | ) ) | ) ) | ( ( | ( ( | |
| | Concave | Convex | Convex | Concave | Concave | Convex | Convex | |
| | Convex | Concave | Convex | Convex | Convex | Concave | Concave | |

Table 9 illustrates a surface profile of each lens of the optical system illustrated in any one of FIG. 1a, FIG. 2a, FIG. 3a, FIG. 4a, FIG. 5a, and FIG. 6a at a periphery.

TABLE 9

| | L1 | L2 | L3 | L4 | L5 | L6 | L7 | |
|---|---|---|---|---|---|---|---|---|
| FIG. 1a | ( ( | ( ( | ) ) | ) ) | ) ( | ) ) | ) ) | At |
| | Convex | Convex | Concave | Concave | Concave | Concave | Concave | a |
| | Concave | Concave | Convex | Convex | Concave | Convex | Convex | Periphery |
| FIG. 2a | ( ( | ( ( | ) ) | ) ) | ) ( | ) ) | ) ) | |
| | Convex | Convex | Concave | Concave | Concave | Concave | Concave | |
| | Concave | Concave | Convex | Convex | Concave | Convex | Convex | |
| FIG. 3a | ( ( | ( ( | ) ) | ) ) | ) ( | ) ) | ) ) | |
| | Convex | Convex | Concave | Concave | Concave | Concave | Concave | |
| | Concave | Concave | Convex | Convex | Concave | Convex | Convex | |
| FIG. 4a | ( ( | ( ( | ) ) | ) ) | ( ( | ) ) | ) ) | |
| | Convex | Convex | Concave | Concave | Convex | Concave | Concave | |
| | Concave | Concave | Convex | Convex | Concave | Convex | Convex | |
| FIG. 5a | ( ( | ( ( | ( ) | ) ) | ( ( | ) ) | ) ) | |
| | Convex | Convex | Convex | Concave | Convex | Concave | Concave | |
| | Concave | Concave | Convex | Convex | Concave | Convex | Convex | |
| FIG. 6a | ( ( | ( ( | ( ) | ) ) | ) ( | ) ) | ) ) | |
| | Convex | Convex | Convex | Concave | Concave | Concave | Concave | |
| | Concave | Concave | Convex | Convex | Concave | Convex | Convex | |

Table 10 illustrates a value of ImghlfnoxL of the optical system illustrated in any one of FIG. 1a, FIG. 2a, FIG. 3a, FIG. 4a, FIG. 5a, and FIG. 6a. It can be seen from Table 10 that the optical system in each implementation satisfies the following expression: 1.2<Imgh/fnoxL<1.4.

TABLE 10

| | 1.2 < Imgh/fno × L < 1.4 | |
|---|---|---|
| Optical System of FIG. 1a | 5.3/2*2.04 | 1.30 |
| Optical System of FIG. 2a | 5.3/2*2.08 | 1.27 |
| Optical System of FIG. 3a | 5.3/2*2.06 | 1.29 |
| Optical System of FIG. 4a | 5.3/2*2.02 | 1.31 |
| Optical System of FIG. 5a | 5.3/2.1*1.98 | 1.27 |
| Optical System of FIG. 6a | 5.3/2.1*1.98 | 1.27 |

Table 11 illustrates a value of Imghlf of the optical system illustrated in any one of FIG. 1a, FIG. 2a, FIG. 3a, FIG. 4a, FIG. 5a, and FIG. 6a. It can be seen from Table 11 that the optical system in each implementation satisfies the following expression: 1.1<Imghlf<1.3.

TABLE 11

| | 1.1 < Imgh/f < 1.3 | |
|---|---|---|
| Optical System of FIG. 1a | 5.3/4.34 | 1.22 |
| Optical System of FIG. 2a | 5.3/4.41 | 1.20 |
| Optical System of FIG. 3a | 5.3/4.37 | 1.21 |
| Optical System of FIG. 4a | 5.3/4.21 | 1.26 |
| Optical System of FIG. 5a | 5.3/4.32 | 1.23 |
| Optical System of FIG. 6a | 5.3/4.30 | 1.23 |

Table 12 illustrates a value of FOV of the optical system illustrated in any one of FIG. 1a, FIG. 2a, FIG. 3a, FIG. 4a, FIG. 5a, and FIG. 6. It can be seen from Table 12 that the optical system in each implementation satisfies the following expression: 90°<FOV<110°.

TABLE 12

| | 90° < FOV < 110° | |
|---|---|---|
| Optical System of FIG. 1a | 99.66° | 99.66° |
| Optical System of FIG. 2a | 98.98° | 98.98° |
| Optical System of FIG. 3a | 98.92° | 98.92° |
| Optical System of FIG. 4a | 101.26° | 101.26° |
| Optical System of FIG. 5a | 101.3° | 101.3° |
| Optical System of FIG. 6a | 101.2° | 101.2° |

Table 13 illustrates a value of TAN(FOV/2)/TTL of the optical system illustrated in any one of FIG. 1a, FIG. 2a, FIG. 3a, FIG. 4a, FIG. 5a, and FIG. 6. It can be seen from Table 13 that the optical system in each implementation satisfies the following expression: 0.13<TAN(FOV/2)/TTL<0.20.

TABLE 13

| | 0.13 < TAN(FOV/2)/TTL < 0.20 | |
|---|---|---|
| Optical System of FIG. 1a | 1.18/7.21 | 0.16 |
| Optical System of FIG. 2a | 1.17/7.28 | 0.16 |
| Optical System of FIG. 3a | 1.14/7.29 | 0.16 |
| Optical System of FIG. 4a | 1.22/8.17 | 0.15 |
| Optical System of FIG. 5a | 1.22/8.37 | 0.15 |
| Optical System of FIG. 6a | 1.22/8.28 | 0.15 |

Table 14 illustrates a value of D1/Imgh of the optical system illustrated in any one of FIG. 1a, FIG. 2a, FIG. 3a, FIG. 4a, FIG. 5a, and FIG. 6. It can be seen from Table 14 that the optical system in each implementation satisfies the following expression: 1<D1/Imgh<1.4.

TABLE 14

| | 1 < D1/Imgh < 1.4 | |
|---|---|---|
| Optical System of FIG. 1a | 6.20/5.3 | 1.17 |
| Optical System of FIG. 2a | 6.22/5.3 | 1.17 |
| Optical System of FIG. 3a | 6.26/5.3 | 1.18 |
| Optical System of FIG. 4a | 6.55/5.3 | 1.24 |
| Optical System of FIG. 5a | 6.44/5.3 | 1.21 |
| Optical System of FIG. 6a | 6.28/5.3 | 1.18 |

Table 15 illustrates a value of DlIL of the optical system illustrated in any one of FIG. 1a, FIG. 2a, FIG. 3a, FIG. 4a, FIG. 5a, and FIG. 6. It can be seen from Table 15 that the optical system in each implementation satisfies the following expression: 2<D1/L<3.5.

TABLE 15

| | 2 < D1/L < 3.5 | |
|---|---|---|
| Optical System of FIG. 1a | 6.20/2.04 | 3.04 |
| Optical System of FIG. 2a | 6.22/2.04 | 3.05 |
| Optical System of FIG. 3a | 6.26/2.04 | 3.07 |
| Optical System of FIG. 4a | 6.55/2.04 | 3.21 |
| Optical System of FIG. 5a | 6.44/2.04 | 3.15 |
| Optical System of FIG. 6a | 6.28/2.04 | 3.08 |

Table 16 illustrates a value of f5/R12 of the optical system illustrated in any one of FIG. 1a, FIG. 2a, FIG. 3a, FIG. 4a, FIG. 5a, and FIG. 6. It can be seen from Table 16 that the optical system in each implementation satisfies the following expression: −3.5<f5/R12<−2.

TABLE 16

| | −3.5 < f5/R12 < −2 | |
|---|---|---|
| Optical System of FIG. 1a | 3.69/−1.1876 | −3.1071 |
| Optical System of FIG. 2a | 3.76/−1.1928 | −3.1522 |
| Optical System of FIG. 3a | 3.75/−1.1917 | −3.1468 |
| Optical System of FIG. 4a | 3.92/−1.4487 | −2.7059 |
| Optical System of FIG. 5a | 4.04/−1.4646 | −2.7584 |
| Optical System of FIG. 6a | 4.03/−1.4534 | −2.7728 |

Table 17 illustrates a value of BFL of the optical system illustrated in any one of FIG. 1a, FIG. 2a, FIG. 3a, FIG. 4a, FIG. 5a, and FIG. 6. It can be seen from Table 17 that the optical system in each implementation satisfies the following expression: 1<BFL<1.2.

TABLE 17

| | 1 < BFL < 1.2 | |
|---|---|---|
| Optical System of FIG. 1a | 1.07 | 1.07 |
| Optical System of FIG. 2a | 1.11 | 1.11 |
| Optical System of FIG. 3a | 1.12 | 1.12 |
| Optical System of FIG. 4a | 1.17 | 1.17 |
| Optical System of FIG. 5a | 1.16 | 1.16 |
| Optical System of FIG. 6a | 1.14 | 1.14 |

Table 18 illustrates a value of BFL of the optical system illustrated in any one of FIG. 1a, FIG. 2a, FIG. 3a, FIG. 4a, FIG. 5a, and FIG. 6. It can be seen from Table 18 that the optical system in each implementation satisfies the following expression: 1.5<TTL/f<2.

TABLE 18

| | 1.5 < TTL/f < 2 | |
|---|---|---|
| Optical System of FIG. 1a | 7.21/4.34 | 1.6613 |
| Optical System of FIG. 2a | 7.28/4.41 | 1.6508 |
| Optical System of FIG. 3a | 7.29/4.37 | 1.6682 |
| Optical System of FIG. 4a | 8.17/4.21 | 1.9406 |
| Optical System of FIG. 5a | 8.37/4.32 | 1.9375 |
| Optical System of FIG. 6a | 8.28/4.30 | 1.9256 |

Table 19 illustrates a value of |R11+R12|/R11×R12 of the optical system illustrated in any one of FIG. 1a, FIG. 2a, FIG. 3a, FIG. 4a, FIG. 5a, and FIG. 6. It can be seen from Table 19 that the optical system in each implementation satisfies the following expression: 1.7<|R11+R12|/R11×R12<2.2.

TABLE 19

| | 1.7 < \|R11 + R12\|R11 × R12 < 2.2 | |
|---|---|---|
| Optical System | \| (−2.1183) + (−1.1876) \|/ (−2.1183) * (−1.1876) | 1.85 |
| of FIG. 1a | | |
| Optical System | \| (−2.0954) + (−1.1928) \|/ (−2.0954) * (−1.1928) | 1.87 |
| of FIG. 2a | | |
| Optical System | \| (−2.0935) + (−1.1917) \|/ (−2.0935) * (−1.1917) | 1.87 |
| of FIG. 3a | | |
| Optical System | \| (−3.6114) + (−1.4487) \|/ (−3.6114) * (−1.4487) | 2.03 |
| of FIG. 4a | | |
| Optical System | \| (−3.5025) + (−1.4646) \|/ (−3.5025) * (−1.4646) | 2.08 |
| of FIG. 5a | | |
| Optical System | \| (−3.4492) + (−1.4534) \|/ (−3.4492) * (−1.4534) | 2.07 |
| of FIG. 6a | | |

Table 20 illustrates a value of |R9+R10|/|R9−R10| of the optical system illustrated in any one of FIG. 1a, FIG. 2a, FIG. 3a, FIG. 4a, FIG. 5a, and FIG. 6. It can be seen from Table 20 that the optical system in each implementation satisfies the following expression: 2<|R9+R10|/|R9−R10|<4.5.

TABLE 20

| | 2 < \|R9 + R10\|/\|R9 − R10\| < 4.5 | |
|---|---|---|
| Optical System of FIG. 1a | \| (−3.3174) + (−8.2371) \|/\| (−3.3174) − (−8.2371) \| | 2.35 |
| Optical System of FIG. 2a | \| (−3.3663) + (−8.4221) \|/\| (−3.3663) − (−8.4221) \| | 2.33 |
| Optical System of FIG. 3a | \| (−3.3844) + (−8.5510) \|/\| (−3.3844) − (−8.5510) \| | 2.31 |
| Optical System of FIG. 4a | \| (−4.6345) + (−8.0341) \|/\| (−4.6345) − (−8.0341) \| | 3.73 |
| Optical System of FIG. 5a | \| (−4.8654) + (−7.9774) \|/\| (−4.8654) − (−7.9774) \| | 4.13 |
| Optical System of FIG. 6a | \| (−9.7480) + (−43.1622) \|/\| (−9.7480) − (−43.1622) \| | 1.58 |

Table 21 illustrates a value of ΣCT/f of the optical system illustrated in any one of FIG. 1a, FIG. 2a, FIG. 3a, FIG. 4a, FIG. 5a, and FIG. 6. It can be seen from Table 21 that the optical system in each implementation satisfies the following expression: 0.85<ΣCT/f<1.2.

TABLE 21

| | 0.85 < ΣCT/f < 1.2 | |
|---|---|---|
| Optical System of FIG. 1a | 4.08/4.34 | 0.94 |
| Optical System of FIG. 2a | 4.08/4.41 | 0.93 |
| Optical System of FIG. 3a | 4.09/4.37 | 0.94 |
| Optical System of FIG. 4a | 4.67/4.21 | 1.11 |
| Optical System of FIG. 5a | 4.73/4.32 | 1.10 |
| Optical System of FIG. 6a | 4.69/4.30 | 1.09 |

Table 22 illustrates a value of ET15/CT15 of the optical system illustrated in any one of FIG. 1a, FIG. 2a, FIG. 3a, FIG. 4a, FIG. 5a, and FIG. 6. It can be seen from Table 22 that the optical system in each implementation satisfies the following expression: 0.7<ET15/CT15<1.2.

TABLE 22

| | 0.7 < ET15/CT15 < 1.2 | |
|---|---|---|
| Optical System of FIG. 1a | 0.47/0.50 | 0.94 |
| Optical System of FIG. 2a | 0.40/0.50 | 0.80 |
| Optical System of FIG. 3a | 0.39/0.50 | 0.78 |
| Optical System of FIG. 4a | 0.47/0.50 | 0.94 |
| Optical System of FIG. 5a | 0.51/0.51 | 1.00 |
| Optical System of FIG. 6a | 0.46/0.51 | 0.90 |

Preferred implementations of the present disclosure have been described above, which cannot be understood as limitations on the present disclosure. Those skilled in the art can appreciate all or part of processes of carrying out the above-mentioned implementations, make equivalent changes based on the claims of the present disclosure, and these equivalent changes are also considered to fall into the protection scope of the present disclosure.

What is claimed is:

1. An optical system comprising, in order from an object side to an image side along an optical axis:
a first lens with a refractive power;
a second lens with a refractive power, wherein the second lens has an object-side surface which is convex and an image-side surface which is concave;
a third lens with a positive refractive power, wherein the third lens has an image-side surface which is convex;
a fourth lens with a negative refractive power, wherein the fourth lens has an object-side surface which is concave and an image-side surface which is convex;
a fifth lens with a positive refractive power;
a sixth lens with a negative refractive power; and
a seventh lens with a refractive power, wherein
the optical system further comprises a stop, and the optical system satisfies the following expression:
1.2<Imgh/fno×L<1.4;
wherein Imgh represents half of a diagonal length of an imaging plane of the optical system, fno represents an F-number of the optical system, and L represents an aperture of the stop.

2. The optical system of claim 1, wherein the first lens has an object-side surface which is concave at the optical axis and an image-side surface which is convex at the optical axis, and wherein the object-side surface of the first lens is convex at a periphery of the object-side surface of the first lens and the image-side surface of the first lens is concave at a periphery of the image-side surface of the first lens.

3. The optical system of claim 1, wherein the fifth lens has an object-side surface which is concave at the optical axis and an image-side surface which is convex at the optical axis, and wherein the image-side surface of the fifth lens is concave at a periphery of the image-side surface of the fifth lens.

4. The optical system of claim 1, wherein
the sixth lens has an object-side surface which is convex at the optical axis and an image-side surface which is concave at the optical axis, and the seventh lens has an object-side surface which is convex at the optical axis and an image-side surface which is concave at the optical axis; and
the object-side surface of the sixth lens is concave at a periphery of the object-side surface of the sixth lens and the image-side surface of the sixth lens is convex at a periphery of the image-side surface of the sixth lens, and the object-side surface of the seventh lens is concave at a periphery of the object-side surface of the seventh lens and the image-side surface of the seventh lens is convex at a periphery of the image-side surface of the seventh lens.

5. The optical system of claim 1, wherein the optical system satisfies the following expression:
1<D1/Imgh<1.4;
wherein D1 represents a clear aperture diameter of the first lens.

6. The optical system of claim 1, wherein the optical system satisfies the following expression:
2<D1/L<3.5;
wherein D1 represents a clear aperture diameter of the first lens of the optical system.

7. The optical system of claim 1, wherein the optical system satisfies the following expression:
90°<FOV<110°;
wherein FOV represents an angle of view of the optical system.

8. The optical system of claim 1, wherein the optical system satisfies the following expression:
1.1<Imgh/f<1.3;
wherein Imgh represents the half of the diagonal length of the imaging plane of the optical system, and f represents an effective focal length of the optical system.

9. The optical system of claim 1, wherein the optical system satisfies the following expression:
0.13<TAN(FOV/2)/TTL<0.20;
wherein TAN(FOV/2) represents a tangent of half of a field of view (FOV) of the optical system, and TTL represents a distance on the optical axis from an object-side surface of the first lens to an imaging plane of the optical system.

10. The optical system of claim 1, wherein the optical system satisfies the following expression:
1<BFL<1.2;
wherein BFL represents a minimum distance between an image-side surface of the seventh lens and the imaging surface in a direction parallel to the optical axis.

11. The optical system of claim 1, wherein the optical system satisfies the following expression:
1.5<TTL/f<2;
wherein TTL represents a distance on the optical axis from an object-side surface of the first lens to the imaging plane of the optical system, and f represents an effective focal length of the optical system.

12. The optical system of claim 1, wherein the optical system satisfies the following expression:
0.85<ΣCT/f<1.2;
wherein ΣCT represents a sum of a center thickness of each lens of the optical system on the optical axis, and f represents an effective focal length of the optical system.

13. The optical system of claim 1, wherein the optical system satisfies the following expression:
2<|R9+R10|/|R9−R10|<4.5;
wherein R9 represents a radius of curvature of the object-side surface of the fourth lens, and R10 represents a radius of curvature of the image-side surface of the fourth lens.

14. The optical system of claim 1, wherein the optical system satisfies the following expression:
−3.5<f5/R12<−2;
wherein f5 represents an effective focal length of the fifth lens, and R12 represents a radius of curvature of an image-side surface of the fifth lens.

15. The optical system of claim 1, wherein the optical system satisfies the following expression:
1.7<|R11+R12|/|R11×R12<2.2;
wherein R11 represents a radius of curvature of an object-side surface of the fifth lens, and R12 represents a radius of curvature of an image-side surface of the fifth lens.

16. The optical system of claim 1, wherein the optical system satisfies the following expression:
0.7<ET15/CT15<1.2;
wherein ET15 represents a center thickness of the seventh lens on a periphery, and CT15 represents a center thickness of the seventh lens on the optical axis.

17. A lens module, comprising:
a lens barrel; and
an optical system comprising, in order from an object side to an image side along an optical axis:
a first lens with a refractive power;
a second lens with a refractive power, wherein the second lens has an object-side surface which is convex and an image-side surface which is concave;
a third lens with a positive refractive power, wherein the third lens has an image-side surface which is convex;
a fourth lens with a negative refractive power, wherein the fourth lens has an object-side surface which is concave and an image-side surface which is convex;
a fifth lens with a positive refractive power;
a sixth lens with a negative refractive power; and
a seventh lens with a refractive power, wherein
the optical system further comprises a stop, and the optical system satisfies the following expression:
1.2<Imgh/fno×L<1.4;
wherein Imgh represents half of a diagonal length of an imaging plane of the optical system, fno represents an F-number of the optical system, and L represents an aperture of the stop;
wherein the first to seventh lenses of the optical system are received in the lens barrel.

18. The lens module of claim 17, wherein the first lens has an object-side surface which is concave at the optical axis and an image-side surface which is convex at the optical axis, and wherein the object-side surface of the first lens is convex at a periphery of the object-side surface of the first lens and the image-side surface of the first lens is concave at a periphery of the image-side surface of the first lens.

19. The lens module of claim 17, wherein the fifth lens has an object-side surface which is concave at the optical axis and an image-side surface which is convex at the optical axis, and wherein the image-side surface of the fifth lens is concave at a periphery of the image-side surface of the fifth lens.

20. An electronic device, comprising:
a housing;
an electronic photosensitive element; and
the lens module of claim 17;
wherein the lens module and the electronic photosensitive element are received in the housing, and the electronic photosensitive element is disposed on the imaging plane of the optical system and configured to convert lights of an object passing through the first to seventh lenses and incidenting on the electronic photosensitive element into an electrical signal of an image.
